(19) United States
(12) Patent Application Publication
(10) Pub. No.: US 2019/0128183 A1
(43) Pub. Date: May 2, 2019

(54) CONTROL DEVICE AND CONTROL METHOD OF GASIFICATION COMBINED CYCLE POWER PLANT, AND GASIFICATION COMBINED CYCLE POWER PLANT

(71) Applicant: Mitsubishi Hitachi Power Systems, Ltd., Yokohama-shi, Kanagawa (JP)

(72) Inventors: Hisanori Morii, Yokohama-shi (JP); Yasuhiro Takashima, Yokohama-shi (JP); Tetsuya Yabe, Yokohama-shi (JP); Takahiko Sakaki, Yokohama-shi (JP)

(73) Assignee: Mitsubishi Hitachi Power Systems, Ltd., Yokohama-shi, Kanagawa (JP)

(21) Appl. No.: 16/094,126

(22) PCT Filed: Apr. 18, 2017
(86) PCT No.: PCT/JP2017/015515

§ 371 Date: Oct. 16, 2018

(30) Foreign Application Priority Data
Apr. 26, 2016 (JP) 2016-088290
Dec. 19, 2016 (JP) 2016-245032

(51) Int. Cl. F02C 3/28; F02C 7/057; F02C 7/232; F02C 9/28; F02C 9/40; F23R 3/26

(52) U.S. Cl. CPC F02C 3/28; F02C 7/057; F23R 3/26; F02C 9/28; F02C 9/40; F02C 7/232

(57) ABSTRACT

A control device of the gasification combined cycle power plant includes: a casing pressure calculation part that calculates a casing pressure of the gas turbine; a pipe pressure loss calculation part that calculates a pressure loss in the pipe from the flow control valve to a combustor of the gas turbine; an outlet pressure calculation part that calculates an outlet pressure of the flow control valve based on the casing pressure calculated by the casing pressure calculation part and the pressure loss calculated by the pipe pressure loss calculation part; and an opening degree command calculation part configured to obtain an opening degree command for the flow control valve based on a fuel flow rate command for the gas turbine, a calculation result of the outlet pressure obtained by the outlet pressure calculation part, and a measured value of a differential pressure of the flow control valve.

### TECHNICAL FIELD

The present disclosure relates to a control device and a control method of a gasification combined cycle power plant, and to a gasification combined cycle power plant.

### BACKGROUND ART

As a power plant having high power generation efficiency, a gasification combined cycle power plant in which a combustible gas obtained by gasifying a solid fuel is used as fuel to drive a turbine is commonly known. For example, in an integrated coal gasification combined cycle power plant (IGCC), a combustible gas is generated by gasifying pulverized coal in a gasification furnace, and a gas turbine is driven with this combustible gas as fuel to generate electric power by a power generator coupled to the gas turbine. Moreover, a steam turbine is driven with steam generated from exhaust heat of the gas turbine, which further increases the power generation efficiency.

In a typical gasification combined cycle power plant, a pressure control valve and a flow control valve are provided in a fuel supply pipe from a gasification furnace to a combustor of the gas turbine. The opening degree of the flow control valve is controlled by a control command that takes into account calorific fluctuations of fuel (combustible gas) while the operation state of the gas turbine is monitored. The flow control valve adjusts the flow rate of the fuel supplied to the combustor, and a heat input into the gas turbine is thereby controlled. The pressure control valve is disposed upstream of the flow control valve, and is configured to secure the stability of wide-range control of the flow control valve while absorbing pressure fluctuations etc. of the fuel attributable to upstream facilities, such as a gasification furnace and a gas purification facility.

In the case where the pressure control valve and the flow control valve are provided in the fuel supply pipe, it is necessary to give a certain amount of pressure loss to these valves in order to achieve adequate controllability, which, however, means that the pressure loss in each valve increases accordingly. As a result, the required gas pressure of the combustible gas generated in the gasification furnace rises, causing an increase in the cost of the gasification furnace.

Therefore, an attempt has been made to reduce the pressure loss by reducing the number of valves provided in the fuel supply pipe, and to thereby reduce the cost of the plant as a whole. For example, Patent Literature 1 describes a configuration in which a pressure control valve is omitted and only a flow control valve is disposed in a fuel supply pipe.

Although this is not related to a gasification combined cycle power plant, Patent Literature 2 describes a configuration in which one flow control valve is disposed in each of fuel supply pipes that are connected respectively to a plurality of nozzles of a combustor.

### CITATION LIST

### Patent Literature

Patent Literature 1: International Publication No. 2008/149731

Patent Literature 2: International Publication No. 2013/105406

### SUMMARY OF INVENTION

### Technical Problem

In the configuration in which, as described above, a pressure control valve is omitted and only a flow control valve is disposed in a fuel supply pipe of a gas turbine, the flow control valve requires to be controlled with higher accuracy for the lack of the buffer function that is realized by giving a pressure loss to the pressure control valve.

In this respect, neither of Patent Literatures 1 and 2 discloses a specific configuration for controlling the flow control valve with high accuracy.

In view of this situation, at least some embodiments of the present invention aim to provide a control device and a control method of a gasification combined cycle power plant and a gasification combined cycle power plant that allow a flow control valve to be controlled with high accuracy even when a pressure control valve is omitted from a fuel supply pipe of a gas turbine.

### Solution to Problem

(1) A control device of a gasification combined cycle power plant according to at least some embodiments of the present invention is a control device of a gasification combined cycle power plant including a gasification furnace, a gas turbine configured to be driven with a combustible gas generated in the gasification furnace as fuel, and a flow control valve provided in a pipe through which the combustible gas is supplied from the gasification furnace to the gas turbine, the control device including:

a casing pressure calculation part that calculates a casing pressure of the gas turbine;

a pipe pressure loss calculation part that calculates a pressure loss in the pipe from the flow control valve to a combustor of the gas turbine;

an outlet pressure calculation part that calculates an outlet pressure of the flow control valve based on the casing pressure calculated by the casing pressure calculation part and the pressure loss calculated by the pipe pressure loss calculation part; and

an opening degree command calculation part configured to obtain an opening degree command for the flow control valve based on a fuel flow rate command for the gas turbine, a calculation result of the outlet pressure obtained by the outlet pressure calculation part, and a measured value of a differential pressure of the flow control valve or of an inlet pressure of the flow control valve.

In the control device of a gasification combined cycle power plant of (1), the opening degree command for the flow control valve is obtained based on the fuel flow rate command for the gas turbine, the calculation result of the outlet pressure of the flow control valve, and the measured value of the differential pressure of the flow control valve or of the inlet pressure of the flow control valve.

To calculate the outlet pressure of the flow control valve in the process of obtaining the opening degree command, this outlet pressure of the flow control valve is calculated based on the calculation result of the casing pressure and the calculation result of the pressure loss in the pipe from the flow control valve to the combustor. Thus, the opening degree of the flow control valve can be controlled with the pressure loss in the pipe from the flow control valve to the combustor taken into account, which allows for high-accuracy control. Specifically, in the case of an integrated coal gasification combined cycle power plant (IGCC), for example, compared with a gas turbine combined cycle power generation (GTCC), the ratio of the pressure loss in the pipe from the casing to the downstream end of the flow control valve is high relative to the pressure loss in a combustion nozzle. By taking the pressure loss in the pipe into account in calculating the opening degree command value for the flow control valve, therefore, it is possible to correctly obtain the opening degree command value and thereby realize higher-accuracy control. Thus, even when the pressure control valve is omitted from the fuel supply pipe of the gas turbine, fuel can be supplied at a desired flow rate to the combustor. Moreover, the number of instruments used to calculate the opening degree command value can be reduced.

(2) Some embodiments have the configuration of (1), wherein the opening degree command calculation part is configured to obtain the opening degree command based on a measured value of a temperature on a downstream side of the flow control valve.

According to the configuration of (2), the flow control valve is appropriately controlled with the temperature on the downstream side of the flow control valve also taken into account. Thus, the flow rate of the fuel supplied to the combustor can be adjusted with high accuracy.

(3) Some embodiments have the configuration of (1) or (2), wherein the casing pressure calculation part is configured to calculate the casing pressure based on the fuel flow rate command, an IGV opening degree of a compressor of the gas turbine, and an intake air temperature of the compressor.

According to the configuration of (3), the casing pressure of the gas turbine can be calculated with high accuracy based on the fuel flow rate command, the IGV opening degree of the compressor of the gas turbine, and the intake air temperature of the compressor of the gas turbine. Thus, the accuracy of calculation of the outlet pressure of the flow control valve using the calculation result of the casing pressure is increased, which allows for more appropriate opening degree control of the flow control valve.

(4) Some embodiments have the configuration of any one of (1) to (3), wherein the pipe pressure loss calculation part is configured to calculate the pressure loss based on a flow rate of the combustible gas flowing through the flow control valve, a pressure on a downstream side of the flow control valve, and a temperature on the downstream side of the flow control valve.

According to the configuration of (4), the flow rate of the combustible gas and the pressure and the temperature on the downstream side of the flow control valve are taken into account, so that the pressure loss from the flow control valve to the combustor can be calculated with high accuracy. Thus, the accuracy of calculation of the outlet pressure of the flow control valve using the calculation result of the pressure loss is increased, which allows for more appropriate opening degree control of the flow control valve.

(5) Some embodiments have the configuration of any one of (1) to (4), wherein:

a plurality of flow control valves is provided in the pipe in parallel to one another; and

the opening degree command calculation part is configured to obtain the opening degree command that is common to the plurality of flow control valves.

Some gasification combined cycle power plants have a high maximum flow rate of a combustible gas, and therefore have a plurality of flow control valves provided in parallel to one another.

In this case, according to the configuration of (5), the opening degrees of the plurality of flow control valves can be controlled by a simple technique.

(6) Some embodiments have the configuration of (5), wherein the opening degree command calculation part is configured to generate a valve closing command that causes at least one of the plurality of flow control valves to be closed, and generate, for the other flow control valves, an opening degree command for realizing the fuel flow rate command, when the opening degree command common to the plurality of flow control valves reaches a minimum opening degree of the flow control valves.

According to the configuration of (6), when the flow rate of the combustible gas is low, share change control of the plurality of flow control valves is executed in which at least one of the plurality of flow control valves is closed and the flow rate of the combustible gas is adjusted by the other flow control valves. Thus, each flow control valve can be appropriately controlled within a range not smaller than the minimum opening degree.

(7) Some embodiments have the configuration of (5) or (6), wherein the opening degree command calculation part is configured to obtain the opening degree command common to the plurality of flow control valves such that a total flow coefficient of the flow control valves upon reaching the minimum opening degree is maintained during switching of the valves.

According to the configuration of (7), combustion can be stably controlled during a period from a starting time point to an ending time point of switching of the flow control valves (throughout the period of a flow control valve switching interval).

(8) Some embodiments have the configuration of (6) or (7), wherein the opening degree command calculation part is configured to:

calculate a target opening degree of the other flow control valves corresponding to a composite Cv value of the plurality of flow control valves at the minimum opening degree;

calculate the valve closing command that causes the opening degree of the at least one flow control valve to decrease to zero at a first rate; and

calculate the opening degree command that causes the opening degrees of the other flow control valves to increase to the target opening degree at a second rate.

According to the configuration of (8), in the case where the share change control of the plurality of flow control valves is executed in which at least one of the flow control valves is closed and the flow rate of the combustible gas is adjusted by the other flow control valves, the composite Cv value can be maintained between before and after the share change control. Thus, the influence of the share change control of the flow control valves on the flow rate of the combustible gas supplied to the combustor can be reduced.

(9) Some embodiments have the configuration of (8), wherein the first rate and the second rate are set such that a time point at which the opening degree of the at least one flow control valve reaches zero and a time point at which the opening degrees of the other flow control valves reach the target opening degree coincide with each other.

According to the configuration of (9), the first rate and the second rate are set such that the time point at which closing of at least one flow control valve that is to be closed is completed and a time point at which the opening degrees of the other flow control valves reach the target opening degree coincide with each other. Thus, it is possible to suppress fluctuations in the composite Cv value during the share change control of the flow control valves, and thereby to stably adjust the flow rate of the combustible gas supplied to the combustor.

(10) Some embodiments have the configuration of any one of (1) to (9), wherein:

the gasification combined cycle power plant further includes an oil supply pipe through which an oil fuel is supplied to the combustor of the gas turbine, and is configured to be able to switch fuels between the combustible gas from the pipe and the oil fuel from the oil supply pipe; and

the gasification combined cycle power plant is configured to switch from the combustible gas to the oil fuel when, for each of the flow control valves, the opening degree command for realizing the fuel flow rate command reaches a minimum opening degree of the flow control valve.

Some gasification combined cycle power plants are configured to be able to switch fuels between an oil fuel and a combustible gas, for example, in order to use the oil fuel during startup and use the combustible gas as fuel during normal operation.

In the case of a gasification combined cycle power plant having such a configuration, even when the opening degree commands for all the flow control valves reach the minimum opening degree and the flow rate of the combustible gas can no longer be appropriately reduced by the flow control valves, switching from the combustible gas to the oil fuel as in (10) makes it possible to continue stable combustion control.

(11) A control device of a gasification combined cycle power plant according to at least some other embodiments of the present invention is a control device of a gasification combined cycle power plant including a gasification furnace, a gas turbine that is driven with a combustible gas generated in the gasification furnace as fuel, and a plurality of flow control valves provided in parallel to one another in a pipe through which the combustible gas is supplied from the gasification furnace to the gas turbine,

the control device including an opening degree command calculation part that calculates an opening degree command for each of the plurality of flow control valves,

wherein the opening degree command calculation part is configured to:

obtain the opening degree command that is common to the plurality of flow control valves; and

generate a valve closing command that causes at least one of the plurality of flow control valves to close, and generate, for the other flow control valves, an opening degree command for realizing the fuel flow rate command, when the opening degree command common to the plurality of flow control valves reaches a minimum opening degree of the flow control valves.

According to the configuration of (11), even when the maximum flow rate of a combustible gas in the gasification combined cycle power plant is high, providing a plurality of flow control valves in parallel to one another can avoid an increase in size of each flow control valve and reduce costs.

Moreover, giving a common opening degree command to a plurality of flow control valves can simplify the opening degree control of the plurality of flow control valves.

Furthermore, when the flow rate of the combustible gas is low, the share change control of the plurality of flow control valves is executed in which at least one of the flow control valves is closed and the flow rate of the combustible gas is adjusted by the other flow control valves. Thus, each flow control valve can be appropriately controlled within a range not smaller than the minimum opening degree.

(12) Some embodiments have the configuration of any one of (1) to (11), wherein:

the control device further includes an IGV opening degree command generation part that generates an opening degree command value for an IGV of a compressor of the gas turbine; and

the IGV opening degree command generation part is configured to reduce the opening degree command value for the IGV toward a closing side as a fuel ratio of the combustible gas to a total fuel increases, during fuel switching of the gasification combined cycle power plant between the combustible gas and another fuel having a higher calorific value than the combustible gas.

According to the configuration of (12), the IGV opening degree command generation part reduces the opening degree of the IGV as the fuel ratio of the combustible gas increases. Thus, it is possible to avoid a decrease in the turbine inlet temperature associated with the use of a low-calorie combustible gas, and at the same time to improve the combustion stability during fuel switching.

(13) Some embodiments have the configuration of any one of (1) to (12), wherein:

the control device further includes an air bypass valve opening degree command generation part that generates an opening degree command value for an air bypass valve that adjusts an amount of compressed air that is part of compressed air generated in a compressor of the gas turbine and bypasses a combustion region of a combustor of the gas turbine; and

the control device is configured to increase the opening degree command value for the air bypass valve toward an opening side as a fuel ratio of the combustible gas to a total fuel increases, during fuel switching of the gasification combined cycle power plant between the combustible gas and another fuel having a higher calorific value than the combustible gas.

According to the configuration of (13), the air bypass valve opening degree command generation part increases the opening degree of the air bypass valve, and thereby reduces the amount of air flowing into the combustion region of the combustor, as the fuel ratio of the combustible gas increases. Thus, the combustion stability during fuel switching can be improved.

(14) A control device of a gasification combined cycle power plant according to at least some embodiments of the present invention is a control device of a gasification combined cycle power plant including a gasification furnace and a gas turbine configured to be driven with a combustible gas generated in the gasification furnace as fuel,

the control device including an IGV opening degree command generation part that generates an opening degree command value for an IGV of a compressor of the gas turbine,

wherein the IGV opening degree command generation part is configured to reduce the opening degree command value for the IGV toward a closing side as a fuel ratio of the combustible gas to a total fuel increases, during fuel switching of the gasification combined cycle power plant between the combustible gas and another fuel having a higher calorific value than the combustible gas.

Some gasification combined cycle power plants are operated by actuating a gas turbine with a startup fuel, such as an oil fuel, during startup of the gasification combined cycle power plant until a combustible gas is generated in a gasification furnace. In this case, the inlet temperature of the gas turbine or the combustion state in the combustor of the gas turbine may be affected by fluctuations in the fuel ratio of the combustible gas to the total fuel due to a difference in the calorific value between the startup fuel and the combustible gas. This problem is not limited to during startup of a gasification combined cycle power plant, but can also arise when fuels are switched between a combustible gas generated in a gasification furnace and another fuel that has a higher calorie than the combustible gas.

Therefore, some embodiments according to (14) have an object of improving the combustion stability during fuel switching of a gasification combined cycle power plant, and avoiding a decrease in the gas turbine inlet temperature associated with the use of a combustible gas as fuel, instead of the above object (controlling a flow control valve with high accuracy even when a pressure control valve is omitted from a fuel supply pipe of a gas turbine).

According to the configuration of (14), the IGV opening degree command generation part reduces the opening degree of the IGV as the fuel ratio of the combustible gas increases. Thus, it is possible to avoid a decrease in the turbine inlet temperature associated with the use of a low-calorie combustible gas, and at the same time to improve the combustion stability during fuel switching.

(15) Some embodiments have the configuration of (14), wherein the IGV opening degree command generation part is configured to reduce the opening degree command value for the IGV toward the closing side as the fuel ratio of the combustible gas increases, during fuel switching from the other fuel to the combustible gas at startup of the gasification combined cycle power plant.

According to the configuration of (15), during switching of the startup fuel (e.g., kerosene oil) to the combustible gas at startup of the gasification combined cycle power plant, the opening degree of the IGV is reduced as the fuel ratio of the combustible gas increases. Thus, it is possible to improve the combustion stability and keep down in the turbine inlet temperature.

(16) Some embodiments have the configuration of (14) or (15), wherein the IGV opening degree command generation part is configured to generate the opening degree command value that causes the IGV to be fully closed, when the fuel ratio of the combustible gas is 100%.

According to the configuration of (16), the opening degree of the IGV during exclusive combustion of the combustible gas is set to full closure, which can secure a wide range of adjustment of the amount of air through the adjustment of the opening degree of the IGV according to the fuel ratio of the combustible gas.

(17) A gasification combined cycle power plant according to at least some embodiments of the present invention includes:

a gasification furnace;

a gas turbine that is driven with a combustible gas generated in the gasification furnace as fuel;

a flow control valve that is provided in a pipe through which the combustible gas is supplied from the gasification furnace to the gas turbine; and

the control device according to any one of claims 1 to 13 that is configured to control the flow control valve.

According to the configuration of (17), when the gasification combined cycle power plant includes the control device having the configuration as described in (1), the opening degree of the flow control valve can be controlled with the pressure loss in the pipe from the flow control valve to the combustor taken into account, which allows for high-accuracy control. Thus, even when the pressure control valve is omitted from the fuel supply pipe of the gas turbine, fuel can be supplied at a desired flow rate to the combustor.

According to the configuration of (17), when the gasification combined cycle power plant includes the control device having the configuration as described in (11), it is possible to simplify the opening degree control of the plurality of flow control valves by giving a common opening degree command to the plurality of flow control valves. Moreover, it is possible to appropriately control each flow control valve within a range not smaller than the minimum opening degree by executing the share change control of the flow control valves.

(18) A control method of a gasification combined cycle power plant according to at least some embodiments of the present invention is a control method of a gasification combined cycle power plant including a gasification furnace, a gas turbine that is driven with a combustible gas generated in the gasification furnace as fuel, and a flow control valve provided in a pipe through which the combustible gas is supplied from the gasification furnace to the gas turbine, the control method including the steps of:

calculating a casing pressure of the gas turbine;

calculating a pressure loss in the pipe from the flow control valve to a combustor of the gas turbine;

calculating an outlet pressure of the flow control valve based on a calculation result of the casing pressure and a calculation result of the pressure loss; and

obtaining an opening degree command for the flow control valve based on a fuel flow rate command for the gas turbine, a calculation result of the outlet pressure, and a measured value of a differential pressure of the flow control valve or of an inlet pressure of the flow control valve.

According to the control method of a gasification combined cycle power plant of (18), to calculate the outlet pressure of the flow control valve in the process of obtaining the opening degree command for the flow control valve, this outlet pressure of the flow control valve is calculated based on the calculation result of the casing pressure and the calculation result of the pressure loss in the pipe from the flow control valve to the combustor. Thus, the opening degree of the flow control valve can be controlled with the pressure loss in the pipe from the flow control valve to the combustor taken into account, which allows for high-accuracy control. Therefore, even when the pressure control valve is omitted from the fuel supply pipe of the gas turbine, fuel can be supplied at a desired flow rate to the combustor. Moreover, the number of instruments used to calculate the opening degree command value can be reduced.

(19) A control method of a gasification combined cycle power plant according to at least some other embodiments of the present invention is a control method of a gasification combined cycle power plant including a gasification furnace and a gas turbine to be driven with a combustible gas generated in the gasification furnace as fuel,

the control method including a step of generating an opening degree command value for an IGV of a compressor of the gas turbine,

wherein, in the step of generating the opening degree command value for the IGV, the opening degree command value for the IGV is reduced toward a closing side as a fuel ratio of the combustible gas to a total fuel increases, during fuel switching of the gasification combined cycle power plant between the combustible gas and another fuel having a higher calorific value than the combustible gas.

Aimed at solving the problem described in connection with (14), the method of (19) involves reducing the opening degree of the IGV as the fuel ratio of the combustible gas increases. Thus, it is possible to avoid a decrease in the turbine inlet temperature associated with the use of a low-calorie combustible gas, and at the same time to improve the combustion stability during fuel switching.

### Advantageous Effects of Invention

According to at least some embodiments of the present invention, the opening degree of a flow control valve can be controlled with a pressure loss in a pipe from the flow control valve to a combustor taken into account, which allows for high-accuracy control. Thus, even when a pressure control valve is omitted from a fuel supply pipe of a gas turbine, fuel can be supplied at a desired flow rate to the combustor.

### BRIEF DESCRIPTION OF DRAWINGS

FIG. 1 is an overall configuration view of a gasification combined cycle power plant according to an embodiment.

FIG. 2 is a block diagram showing the overall configuration of control of a flow control valve according to an embodiment.

FIG. 3 is a view showing a gasification combined cycle power plant including a control device according to an embodiment.

FIG. 4 is a block diagram showing the specific configuration of a valve opening degree setting unit included in the control device shown in FIG. 3.

FIG. 5 is a view showing a gasification combined cycle power plant including a control device according to another embodiment.

FIG. 6 is a block diagram showing the specific configuration of a valve opening degree setting unit included in the control device shown in FIG. 5.

FIG. 7 is a view showing the overall configuration of a gasification combined cycle power plant including a plurality of flow control valves according to an embodiment.

FIG. 8 is a block diagram showing an example of the configuration of a valve opening degree setting unit included in a control device shown in FIG. 7.

FIG. 9 is a block diagram showing another example of the configuration of the valve opening degree setting unit included in the control device shown in FIG. 7.

FIG. 10 is a block diagram showing yet another example of the configuration of the valve opening degree setting unit included in the control device shown in FIG. 7.

FIG. 11 is a block diagram showing yet another example of the configuration of the valve opening degree setting unit included in the control device shown in FIG. 7.

FIG. 12A is a timing chart showing opening degree control of a plurality of flow control valves (three valves).

FIG. 12B is a timing chart showing opening degree control of a plurality of flow control valves (two valves).

FIG. 13 is a graph showing the characteristics of a composite Cv value of a plurality of flow control valves.

FIG. 14 is a configuration view showing a fuel supply system according to another embodiment.

FIG. 15 is a graph showing an example of relationships of a combustible gas fuel flow rate command and an oil fuel flow rate command to a load during fuel switching.

FIG. 16 is a view showing the configuration of a gasification combined cycle power plant according to an embodiment.

FIG. 17 is a view showing an example of the configuration of a bypass valve of a gas turbine.

FIG. 18 is a view showing an example of the configuration of a combustion liner, in which FIG. 18(a) is a sectional view taken along an axial direction of a combustor, and FIG. 18(b) is a view showing section A-A in FIG. 18(a).

FIG. 19 is a block diagram showing the configuration of a control device of a gasification combined cycle power plant according to an embodiment.

FIG. 20 is a timing chart showing opening degree control of an IGV and a bypass valve during fuel switching according to an embodiment.

### DESCRIPTION OF EMBODIMENTS

In the following, some embodiments of the present invention will be described with reference to the accompanying drawings. The dimensions, materials, shapes, relative arrangement, etc. of components described as embodiments or shown in the drawings are merely illustrative examples and not intended to limit the scope of the present invention thereto.

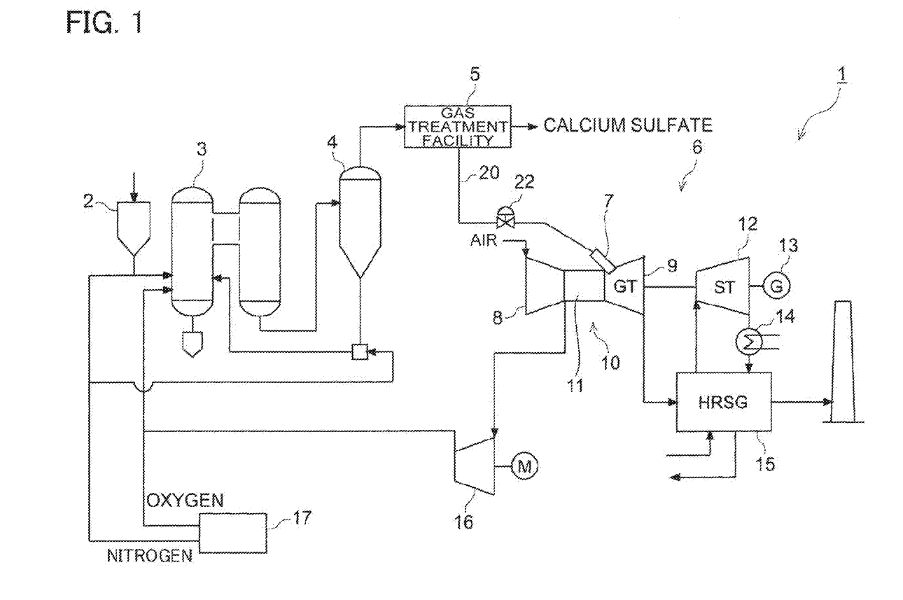

First, the overall configuration of a gasification combined cycle power plant 1 according to some embodiments will be described using FIG. 1 as an example. FIG. 1 is an overall configuration view of the gasification combined cycle power plant 1 according to an embodiment.

In the following embodiment, an integrated coal gasification combined cycle power plant (IGCC) in which coal is used as fuel for a gasification furnace 3 will be described as an example. However, the type of the plant 1 of this embodiment is not limited to this example, and the plant 1 may be a plant that uses another solid fuel, such as coke, petroleum residue, pitch, oil shale, discarded tires, or plastics, as fuel for the gasification furnace 3.

In some embodiments, the gasification combined cycle power plant 1 includes the gasification furnace 3, and a gas turbine 10 that is driven with a combustible gas generated in the gasification furnace 3 as fuel.

More specifically, the gasification combined cycle power plant 1 according to the embodiment shown in FIG. 1 includes a coal feeding facility 2, the gasification furnace 3, a dust removing device 4, a gas treatment facility 5, and a power generation facility 6.

The coal feeding facility 2 is configured to generate pulverized coal by crushing coal with a mill. The coal feeding facility 2 has the pulverized coal transferred to the gasification furnace 3 by a current of nitrogen separated in an air separation device 17.

The gasification furnace 3 is configured to be supplied with the pulverized coal from the coal feeding facility 2, char collected in the dust removing device 4, compressed air from a compressor 16, and oxygen separated in the air separation device 17, and to generate a combustible gas by gasification reactions. The combustible gas generated in the gasification furnace 3 is transferred to the dust removing device 4.

The dust removing device 4 is configured to separate char from the combustible gas from the gasification furnace 3. After the char is removed, the combustible gas is transferred to the gas treatment facility 5. The char separated from the combustible gas is supplied to the gasification furnace 3.

The gas treatment facility 5 generates a combustible gas containing H₂S by converting COS contained in the combustible gas from the dust removing device 4 into H₂S and CO₂, and removes impurities, such as HCl and NH₃, and H₂S from this combustible gas containing H₂S to thereby generate a combustible gas composed mainly of CO and H₂. The combustible gas having been treated in the gas treatment facility 5 is supplied to the power generation facility 6 through a pipe 20.

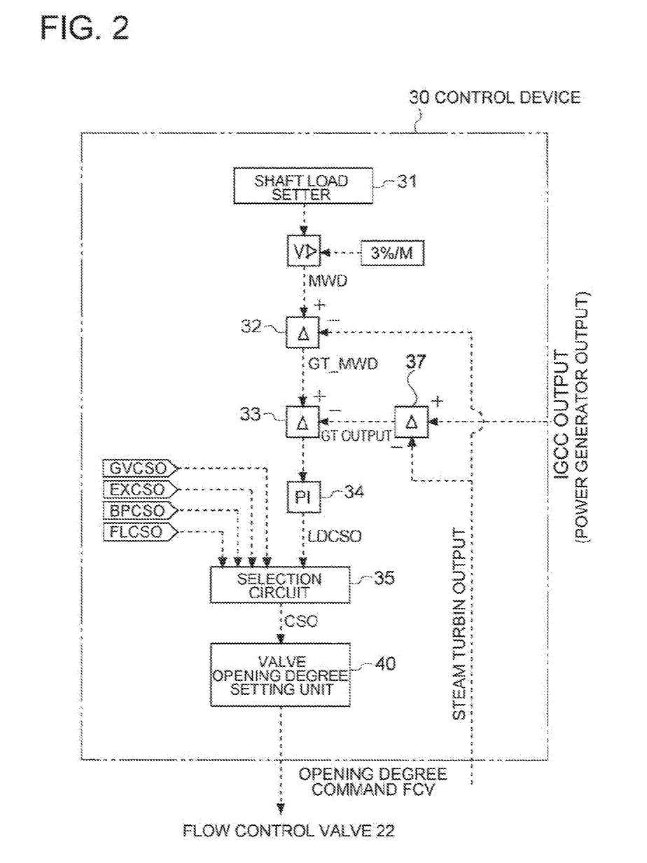

The pipe 20 through which the combustible gas from the side of the gasification furnace 3 (gas treatment facility 5) is supplied to a combustor 7 of the gas turbine 10 is provided with a flow control valve 22 that adjusts the flow rate of the combustible gas supplied to the combustor 7 of the gas turbine 10. The opening degree of the flow control valve 22 is controlled by a control device 30 to be described later with reference to FIG. 2.

The pipe 20 may be provided with a shutoff valve (not shown) that interrupts a supply of the combustible gas supplied to the combustor 7.

The power generation facility 6 includes: the gas turbine 10 including the combustor 7, a compressor 8, and a turbine 9; a power generator 13; a heat recovery steam generator (HRSG) 15; a steam turbine 12; and a condenser 14.

The embodiment shown in FIG. 1 has a configuration in which the gas turbine 10 and the steam turbine 12 have a single-shaft layout and are provided with one power generator 13, but the present invention is not limited to this configuration. For example, a configuration may be adopted in which the gas turbine 10 and the steam turbine 12 have a two-shaft layout with two power generators respectively connected thereto.

In the case where the single-shaft layout of the gas turbine 10 and the steam turbine 12 is adopted, the output of the gas turbine 10 can be obtained by measuring the output of the power generator 13 (IGCC output), for example, with a wattmeter, and subtracting the output of the steam turbine 12 from the measurement result of the IGCC output. On the other hand, in the case where the two-shaft layout of the gas turbine 10 and the steam turbine 12 is adopted, the output of the power generator of the gas turbine 10 may be measured and the measured value may be used as the output of the gas turbine 10. The output of the gas turbine 10 thus obtained is used by the control device 30, to be described later, for opening degree control of the flow control valve 22.

In the gas turbine 10 of the power generation facility 6 having such a configuration, compressed air from the compressor 8 is temporarily stored in a casing 11, and this compressed air is supplied to the combustor 7 of the gas turbine 10. Meanwhile, the combustible gas (fuel) from the gas treatment facility 5 is supplied to the combustor 7 through the pipe 20. The combustible gas is combusted in the combustor 7, and combustion gas is supplied to the turbine 9. The turbine 9 is driven to rotate by the combustion gas from the combustor 7, and in turn drives the compressor 8 through a rotating shaft. Thus, compressed air is generated in the compressor 8.

The combustion gas having rotated the turbine 9 is discharged as exhaust gas and supplied to the heat recovery steam generator 15. The heat recovery steam generator 15 generates steam by heating water supplied from the condenser 14 with the exhaust heat of the exhaust gas from the turbine 9. The steam generated in the heat recovery steam generator 15 is supplied to the steam turbine 12. The steam turbine 12 is driven to rotate by the steam from the heat recovery steam generator 15, and in turn drives the power generator 13 through the rotating shaft along with the gas turbine 10. Thus, electric power is generated in the power generator 13.

The turbine 9 of the gas turbine 10 may be provided with a BPT sensor (not shown) that measures a blade path temperature of the turbine 9. In addition, an EXT sensor (not shown) that measures the temperature of the exhaust gas (hereinafter referred to as an exhaust gas temperature) in an exhaust duct of the gas turbine 10 may be provided on a wake side of the BPT sensor.

State quantities related to the operation state of the gasification combined cycle power plant 1, such as the temperatures measured by the BPT sensor and the EXT sensor, the output of the steam turbine 12 (the output of the power generator 13), and the rotation speed or the number of rotations of the gas turbine 10, may be input into the control device 30 to be described later with reference to FIG. 2. In this case, for example, the measured values of the temperatures obtained by the BPT sensor and the EXT sensor may be respectively used to calculate temperature control commands EXCSO, BPCSO to be described later with reference to FIG. 2.

Next, the outline of opening degree control of the flow control valve 22 in the gasification combined cycle power plant 1 will be described with reference to FIG. 2.

FIG. 2 is a block diagram showing the overall configuration of the control of the flow control valve 22 according to an embodiment.

First, when a target load for the power generator output is set by a shaft load setter 31, a power generator command MWD is set such that the load changes at a plant load change rate (e.g., 3% per minute) toward this target load. A subtractor 32 calculates a gas turbine output command GT_MWD by subtracting the steam turbine output from the power generator command MWD. The gas turbine output command GT_MWD is given to a subtractor 33.

The output of the steam turbine 12 (steam turbine output) may be obtained by calculation, for example, based on a state quantity at the inlet of the steam turbine 12. Alternatively, the output of the steam turbine 12 may be obtained by calculation based on measured values of the number of rotations, the torque, etc. of the steam turbine 12.

Meanwhile, a subtractor 37 calculates the gas turbine output by subtracting the steam turbine output from the output of the gasification combined cycle power plant 1 as a whole (the IGCC output; the sum of the gas turbine output and the steam turbine output). This gas turbine output is input into the subtractor 33. The subtractor 33 subtracts the gas turbine output from the gas turbine output command GT_MWD to obtain the difference therebetween. Based on this difference, a PI controller 34 executes PI control and thereby obtains a load control command LDCSO for matching the gas turbine output with the gas turbine output command GT_MWD. The load control command LDCSO is sent to a selection circuit 35.

Other than the load control command LDCSO, a governor control command GVCSO calculated based on the number of rotations of the shaft, the temperature control commands EXCSO, BPCSO calculated based on the temperatures, and a fuel control command FLCSO calculated based on the amount of fuel are given to the selection circuit 35. The selection circuit 35 selects a control command having the lowest value of these control commands, and outputs the selected control command to a valve opening degree setting unit 40 as a fuel flow rate command CSO. The fuel flow rate command CSO may be given in the form of a variable corresponding to the fuel flow rate.

The valve opening degree setting unit 40 calculates a valve opening degree corresponding to the fuel flow rate command CSO given by the selection circuit 35, and outputs this valve opening degree as an opening degree command FCV for the flow control valve 22.

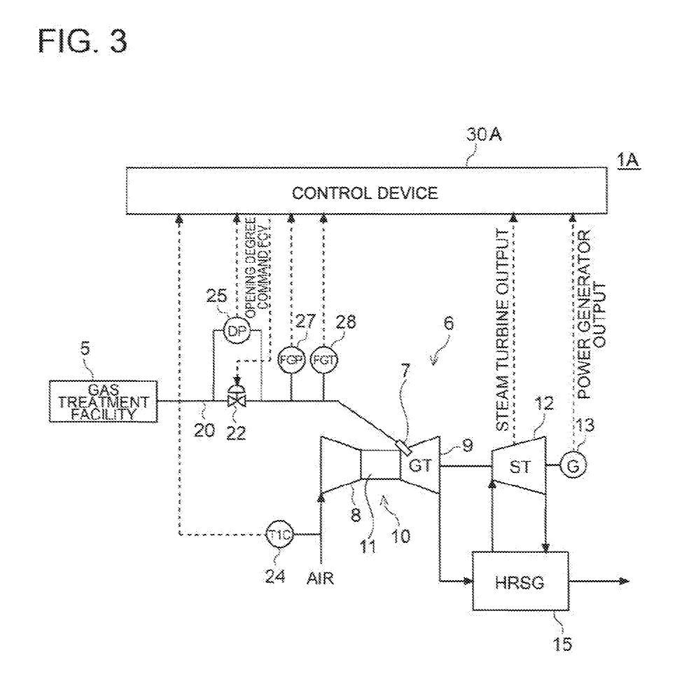

In the following, the control of the flow control valve 22 for adjusting the flow rate of the combustible gas (fuel) supplied to the gas turbine 10 will be specifically described with reference to FIG. 3 to FIG. 6.

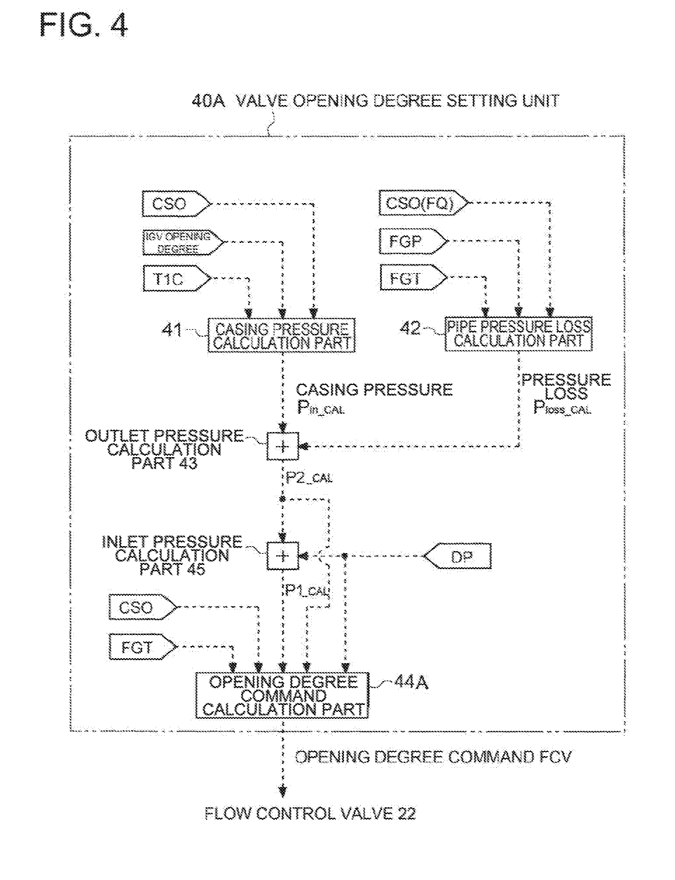

FIG. 3 is a view showing a gasification combined cycle power plant 1A including a control device 30A of the flow control valve 22 according to an embodiment. FIG. 4 is a block diagram showing the specific configuration of a valve opening degree setting unit 40A included in the control device 30A shown in FIG. 3.

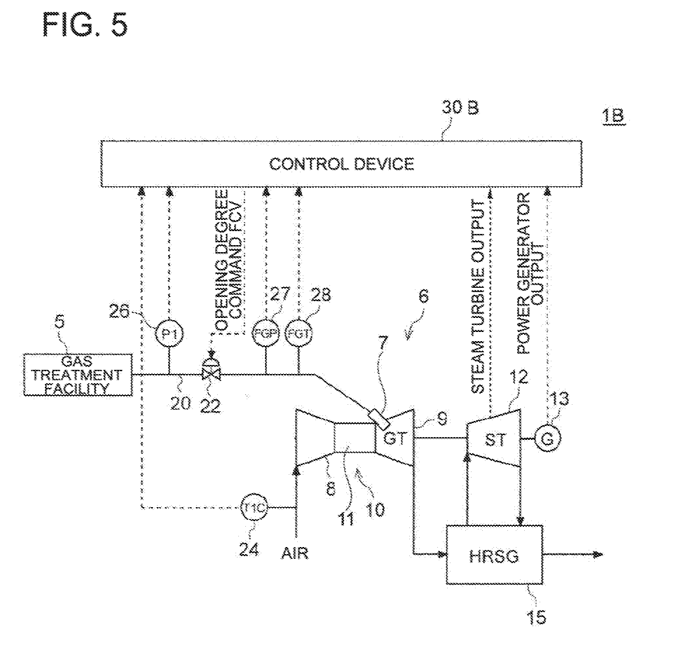

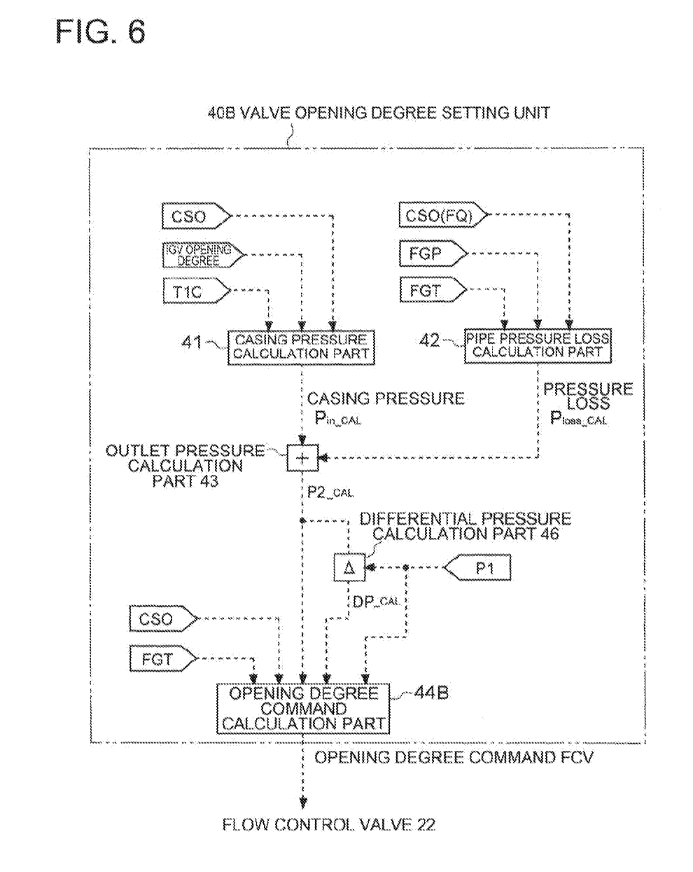

FIG. 5 is a view showing a gasification combined cycle power plant 1B including a control device 30B of the flow control valve 22 according to another embodiment. FIG. 6 is a block diagram showing the specific configuration of a valve opening degree setting unit 40B included in the control device 30B shown in FIG. 5.

Hereinafter, when a component of the embodiment shown in FIG. 3 and FIG. 4 and a component of the embodiment shown in FIG. 5 and FIG. 6 correspond with each other, the former may be denoted by a reference sign with A added at the end and the latter may be denoted by a reference sign with B added at the end. Moreover, when a component in FIG. 3 and FIG. 4 and a component in FIG. 5 and FIG. 6 are collectively referred to, these components may be denoted by only the reference sign (number) without A or B.

First, various instruments used for the opening degree control of the flow control valve 22 by the control device 30 (valve opening degree setting unit 40) shown in FIG. 3 to FIG. 6 will be described.

In the illustrative embodiment shown in FIG. 3, a differential pressure indicator 25 that measures the differential pressure across the flow control valve 22 is provided near the flow control valve 22. On the other hand, in the illustrative embodiment shown in FIG. 5, an inlet pressure indicator 26 that measures an inlet pressure P1 of the flow control valve 22 is provided on the inlet side of the flow control valve 22.

To calculate the opening degree command FCV for the flow control valve 22 in the control device 30 (valve opening degree setting unit 40) to be described below, the gasification combined cycle power plant 1 should include at least one of the differential pressure indicator 25 and the inlet pressure indicator 26.

The gasification combined cycle power plant 1 may further include other instruments. For example, as shown in FIG. 3 and FIG. 5, the gasification combined cycle power plant 1 may include an intake air temperature indicator 24 that measures an intake air temperature T1C of the compressor 8, a downstream-side pressure indicator 27 that measures a pressure FGP on the downstream side of the flow control valve 22, and a downstream-side temperature indicator 28 that measures a temperature FGT on the downstream side of the flow control valve 22.

Measurement results of these various instruments are used by the valve opening degree setting unit 40 of the control device 30 to execute the opening degree control of the flow control valve 22 so as to realize a desired fuel flow rate.

In some embodiments, as shown in FIG. 4 and FIG. 6, the valve opening degree setting unit 40 of the control device 30 includes a casing pressure calculation part 41, a pipe pressure loss calculation part 42, an output pressure calculation part (e.g., adder) 43, and an opening degree command calculation part 44 (44A, 44B).

The casing pressure calculation part 41 is configured to calculate a casing pressure P₁ₙ_{_}_{CAL} of the gas turbine 10.

For example, as shown in FIG. 4 and FIG. 6, the casing pressure calculation part 41 is configured to calculate the casing pressure of the gas turbine 10 based on the fuel flow rate command CSO given from the selection circuit 35 (see FIG. 2), the IGV opening degree of the compressor 8, and the intake air temperature T1C of the compressor 8. In this case, the casing pressure of the gas turbine 10 can be calculated with high accuracy. Thus, the accuracy of calculation of an outlet pressure P2_{—CAL} of the flow control valve 22 using the calculation result (P₁ₙ_{_}_{CAL}) of the casing pressure is increased, which allows for more appropriate opening degree control of the flow control valve 22.

The pipe pressure loss calculation part 42 is configured to calculate a pressure loss Pₗₒₛₛ_{_}_{CAL} in the pipe 20 from the flow control valve 22 to the combustor 7 of the gas turbine 10.

For example, as shown in FIG. 4 and FIG. 6, the pipe pressure loss calculation part 42 is configured to calculate the pressure loss in the pipe 20 based on the fuel flow rate CSO (FQ) of the combustible gas flowing through the flow control valve 22, the pressure (fuel pressure) FGP on the downstream side of the flow control valve 22, and the temperature (fuel temperature) FGT on the downstream side of the flow control valve 22. Thus, the pressure loss from the flow control valve 22 to the combustor 7 can be calculated with high accuracy by taking into account the flow rate of the combustible gas and the pressure FGP and the temperature FGT on the downstream side of the flow control valve 22. As a result, the accuracy of calculation of an outlet pressure P2 of the flow control valve 22 using the calculation result (Pₗₒₛₛ_{_}_{CAL}) of the pressure loss in the pipe 20 is increased, which allows for more appropriate opening degree control of the flow control valve 22.

The outlet pressure calculation part 43 is configured to calculate the outlet pressure P2_{—CAL} of the flow control valve 22 based on the casing pressure P₁ₙ_{_}_{CAL} calculated by the casing pressure calculation part 41 and the pressure loss Pₗₒₛₛ_{_}_{CAL} in the pipe 20 calculated by the pipe pressure loss calculation part 42.

For example, as shown in FIG. 4 and FIG. 6, the outlet pressure calculation part 43 may be an adder that is configured to calculate the outlet pressure P2_{—CAL} of the flow control valve 22 by adding up the casing pressure P₁ₙ_{_}_{CAL} calculated by the casing pressure calculation part 41 and the pressure loss Pₗₒₛₛ_{_}_{CAL} in the pipe 20 calculated by the pipe pressure loss calculation part 42.

In some embodiments, as shown in FIG. 4 and FIG. 6, the opening degree command calculation part 44 (44A, 44B) obtains the opening degree command FCV for the flow control valve 22 based on the fuel flow rate command CSO for the gas turbine 10, the calculation result P2_{—CAL} of the outlet pressure obtained by the outlet pressure calculation part 43, and a differential pressure DP across the flow control valve 22 (the measurement result of the differential pressure indicator 25 shown in FIG. 3) or an inlet pressure P1 of the flow control valve 22 (the measurement result of the inlet pressure indicator 26 shown in FIG. 5).

Thus, the opening degree of the flow control valve 22 can be controlled with the pressure loss in the pipe 20 from the flow control valve 22 to the combustor 7 taken into account, which allows for high-accuracy control. Therefore, even when a pressure control valve is omitted from the fuel supply pipe 20 of the gas turbine 10, fuel can be supplied at a desired flow rate to the combustor 7

Conventionally, calculating an opening degree command value for a flow control valve requires measured values of at least two of the inlet pressure and the outlet pressure of the flow control valve and the differential pressure across the flow control valve, and therefore instruments are installed at two locations. By contrast, in the embodiment described above with reference to FIG. 4 and FIG. 6, the calculated value (P2_{—CAL}) of the outlet pressure of the flow control valve 22 is used to calculate the opening degree command FCV for the flow control valve 22, so that only either the inlet pressure P1 or the differential pressure DP need be measured. Thus, the number of instruments can be reduced from the number of instruments conventionally required.

As shown in FIG. 4 and FIG. 6, the opening degree command calculation part 44 may obtain the opening degree command FCV for the flow control valve 22 based on the temperature (measured value) FGT on the downstream side of the flow control valve 22. In this case, the temperature FGT on the downstream side of the flow control valve 22 is also taken into account to appropriately control the flow control valve 22, which allows for high-accuracy adjustment of the flow rate of the fuel supplied to the combustor 7.

The opening degree command FCV for the flow control valve 22 thus calculated by the opening degree command calculation part 44 is output to the flow control valve 22.

Here, an example of the calculation method of the opening degree command used by the opening degree command calculation part 44 will be described.

In some embodiments, the opening degree command calculation part 44 obtains the opening degree command FCV for the flow control valve 22 according to the fuel flow rate command CSO by using a Cv value (flow coefficient) expressed by the following Formula (1):

$$Cv = k \times {Q}_{g} \sqrt{\frac{{G}_{g} T 1}{DP ( P 1 + P 2 )}} \qquad ( 1 )$$

The symbols in the above Formula (1) denote as follows: k is a proportional constant (k=1/273 in the case of the Cv value calculation formula specified by Fluid Controls Institute Inc. (FCI)); Qg is a volume flow rate (Nm³/h) of a fuel gas; Gg is a specific gravity of the fuel gas relative to air in a normal state; T1 is an inlet temperature (K) of the flow control valve 22; DP is a differential pressure across the flow control valve 22; P1 is an inlet pressure of the flow control valve 22; and P2 is an output pressure of the flow control valve 22.

In the illustrative embodiment shown in FIG. 4, the opening degree command calculation part 44A calculates a Cv value to be realized, by substituting, into the above Formula (1), the measured value DP of the differential pressure across the flow control valve 22, a calculated value P1_{—CAL} of the inlet pressure of the flow control valve 22, the calculated value P2_{—CAL} of the outlet pressure of the flow control valve 22, a desired fuel gas volume flow rate Qg_{—tgt} that is obtained from the fuel flow rate command CSO, the temperature FGT on the downstream side of the flow control valve 22, and an upstream-side temperature T1_{—CAL} that is obtained from the upstream-side pressure P1 and the downstream-side pressure P2, and then obtains an opening degree of the flow control valve 22 corresponding to this Cv value as the opening degree command FCV.

On the other hand, in the illustrative embodiment shown in FIG. 6, the opening degree command calculation part 44B calculates a Cv value to be realized, by substituting, into the above Formula (1), a calculated value DP_{—CAL} of the differential pressure across the flow control valve 22, the measured value P1 of the inlet pressure of the flow control valve 22, the calculated value P2_{—CAL} of the outlet pressure of the flow control valve 22, the desired fuel gas volume flow rate Qg_{—tgt} that is obtained from the fuel flow rate command CSO, the temperature FGT on the downstream side of the flow control valve 22, and the upstream-side temperature T1_{—CAL} that is obtained from the upstream-side pressure P1 and the downstream-side pressure P2, and then obtains an opening degree of the flow control valve 22 corresponding to this Cv value as the opening degree command FCV.

As described above, in the embodiment shown in FIG. 4, the opening degree command calculation part 44A is configured to obtain the opening degree command FCV for the flow control valve 22 based on the fuel flow rate command CSO for the gas turbine 10, the calculation result (P2_{—CAL}) of the outlet pressure obtained by the outlet pressure calculation part 43, and the measured value DP of the differential pressure across the flow control valve 22.

Specifically, the outlet pressure calculation part 43 calculates the outlet pressure P2_{—CAL} of the flow control valve 22 by adding up the casing pressure P₁ₙ_{_}_{CAL} calculated by the casing pressure calculation part 41 and the pressure loss Pₗₒₛₛ_{_}_{CAL} in the pipe 20 calculated by the pipe pressure loss calculation part 42. The inlet pressure calculation part 45 calculates the inlet pressure P_{—CAL} of the flow control valve 22 by adding up the outlet pressure P2_{—CAL} calculated by the outlet pressure calculation part 43 and the differential pressure DP of the flow control valve 22 measured by the differential pressure indicator 25. Then, the opening degree command calculation part 44A calculates the opening degree command FCV for the flow control valve 22 based on the fuel flow rate command CSO, and on the inlet pressure P1_{—CAL} and the outlet pressure P2_{—CAL}, the differential pressure DP, and the downstream-side temperature FGT measured by the downstream-side temperature indicator 28, of the flow control valve 22.

In this configuration, if the existing differential pressure indicator 25 is used, it is not necessary to provide an inlet pressure indicator that measures the inlet pressure P1 of the flow control valve 22, so that the number of control instruments to be installed can be reduced.

On the other hand, in the embodiment shown in FIG. 6, as described above, the opening degree command calculation part 44B is configured to obtain the opening degree command FCV for the flow control valve 22 based on the fuel flow rate command CSO for the gas turbine 10, the calculation result (P2_{—CAL}) of the outlet pressure obtained by the outlet pressure calculation part 43, and the inlet pressure P1 measured by the inlet pressure indicator 26.

Specifically, the outlet pressure calculation part 43 calculates the outlet pressure P2_{—CAL} of the flow control valve 22 by adding up the casing pressure P₁ₙ_{_}_{CAL} calculated by the casing pressure calculation part 41 and the pressure loss Pₗₒₛₛ_{_}_{CAL} in the pipe 20 calculated by the pipe pressure loss calculation part 42. The differential pressure calculation part 46 calculates the differential pressure DP_{—CAL} of the flow control valve 22 based on the difference between the outlet pressure P2_{—CAL} calculated by the outlet pressure calculation part 43 and the inlet pressure P1 measured by the inlet pressure indicator 26. Then, the opening degree command calculation part 44B calculates the opening degree command FCV for the flow control valve 22 based on the fuel flow rate command CSO, and on the inlet pressure P1 and the outlet pressure P2_{—CAL}, the differential pressure DP_{—CAL}, and the downstream-side temperature FGT measured by the downstream-side temperature indicator 28, of the flow control valve 22.

In this configuration, the inlet pressure P1 measured by the inlet pressure indicator 26 is used to calculate the opening degree command FCV for the flow control valve 22, which allows for high-accuracy control of the flow control valve 22.

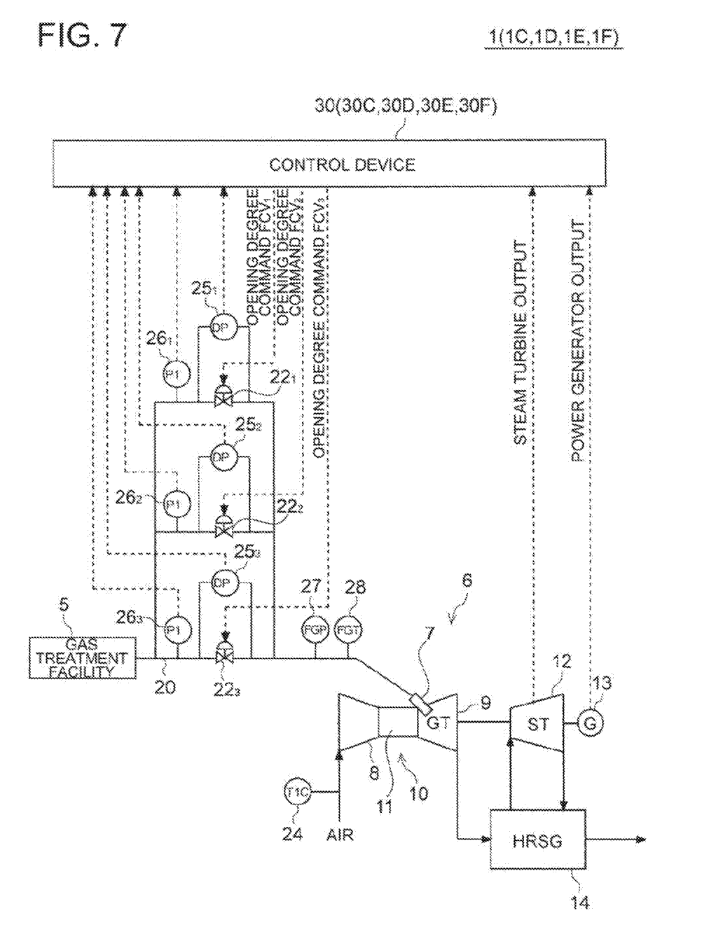

Next, opening degree control of each flow control valve 22 in the case where a plurality of flow control valves 22 is provided will be described with reference to FIG. 7 to FIG. 11.

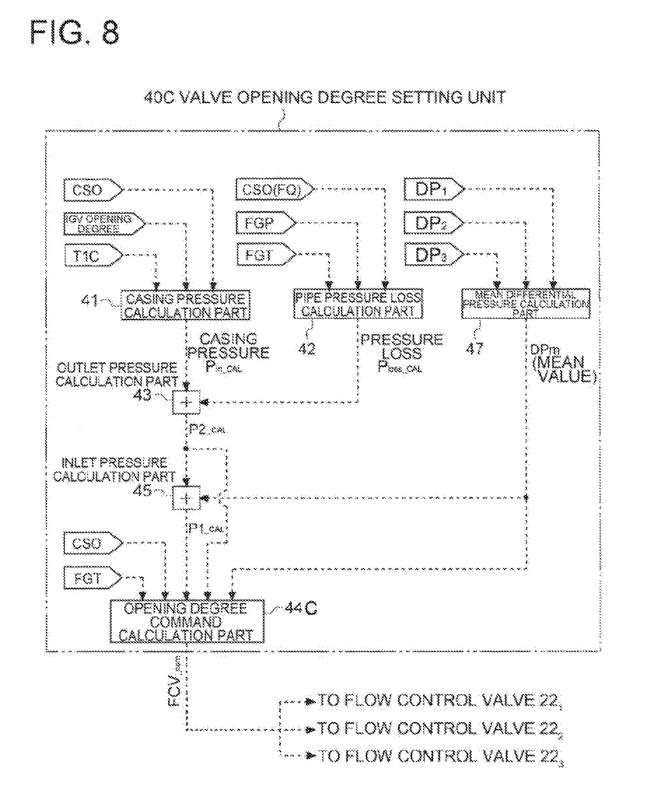

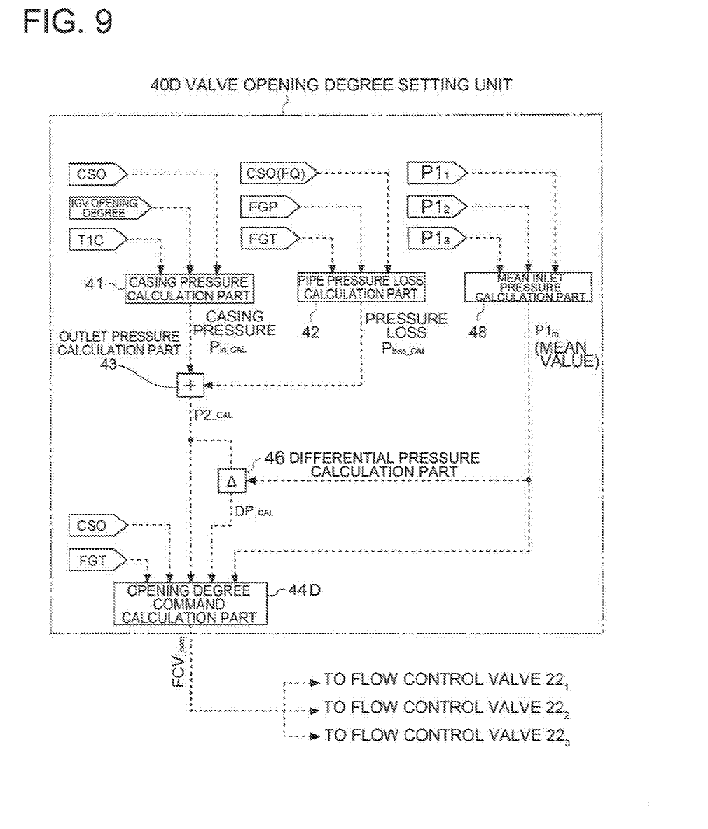

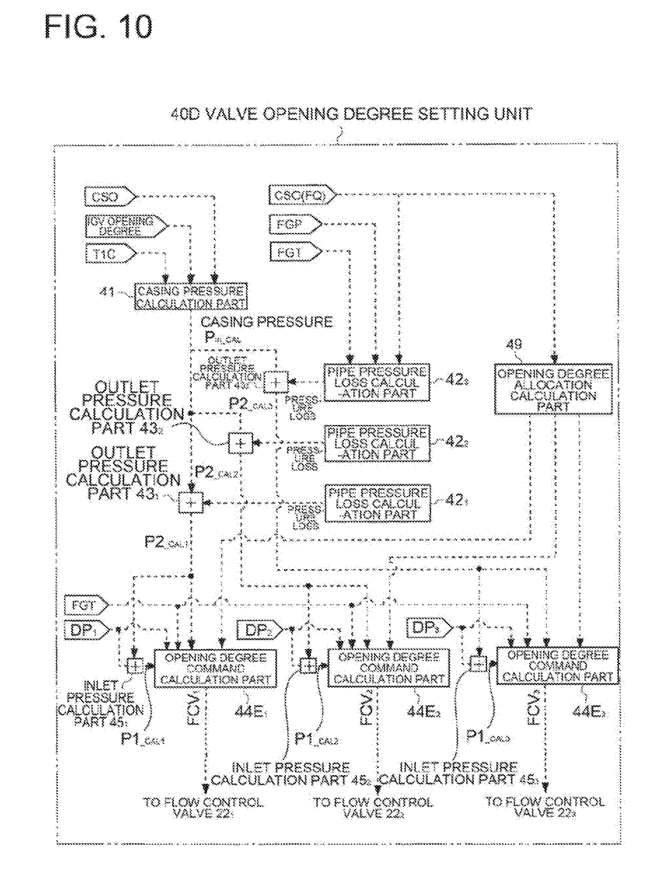

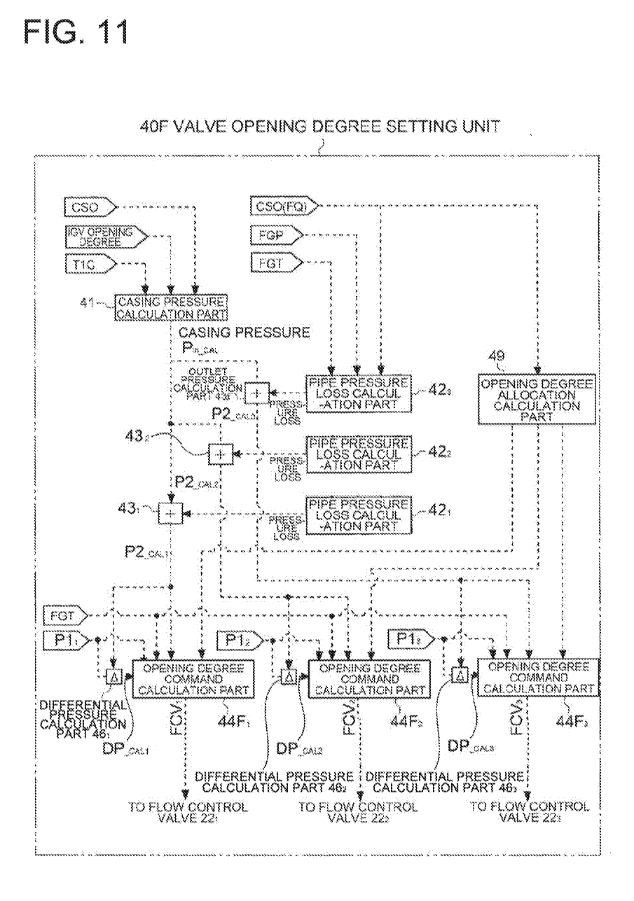

FIG. 7 is a view showing the overall configuration of a gasification combined cycle power plant 1 (1C to 1F) including the plurality of flow control valves 22 according to an embodiment. FIG. 8 is a block diagram showing an example of the configuration of a valve opening degree setting unit 40C included in a control device 30C shown in FIG. 7. FIG. 9 is a block diagram showing an example of the configuration of a valve opening degree setting unit 40D included in a control device 30D shown in FIG. 7. FIG. 10 is a block diagram showing an example of the configuration of a valve opening degree setting unit 40E included in a control device 30E shown in FIG. 7. FIG. 11 is a block diagram showing an example of the configuration of a valve opening degree setting unit 40F included in a control device 30F shown in FIG. 7.

As shown in FIG. 7, in some embodiments, the gasification combined cycle power plant 1 (1C to 1F) includes the plurality of flow control valves 22 (22₁ to 22₃) that is provided in parallel to one another between the gas treatment facility 5 and the gas turbine 10. The opening degree of each of the flow control valves 22 (22₁ to 22₃) is controlled by the control device 30 (30C to 30F) to be described later with reference to FIG. 8 to FIG. 11.

The gasification combined cycle power plant 1 (1C to 1F) includes various instruments used to control the opening degree of each of the flow control valves 22 (22₁ to 22₃).

For example, as shown in FIG. 7, the gasification combined cycle power plant 1 (1C to 1F) may include a plurality of differential pressure indicators 25 (25₁ to 25₃) that respectively measures the differential pressures DP (DP₁ to DP₃) across the flow control valves 22 (22₁ to 2₂₃), and a plurality of inlet pressure indicators 26 (26₁ to 26₃) that respectively measures the inlet pressures P1 (P1₁ to P1₃) of the flow control valves 22 (22₁ to 22₃). While FIG. 7 shows an example where the gasification combined cycle power plant 1 (1C to 1F) includes both the differential pressure indicators 25 (25₁ to 25₃) and the inlet pressure indicators 26 (26₁ to 26₃), the gasification combined cycle power plant 1 (1C to 1F) should include at least either the differential pressure indicators 25 (25₁ to 25₃) or the inlet pressure indicators 26 (26₁ to 26₃).

In addition, the gasification combined cycle power plant 1 may further include the intake air temperature indicator 24 that measures the intake air temperature T1C of the compressor 8, the downstream-side pressure indicator 27 that measures the downstream-side pressure FGP of the flow control valves 22 (22₁ to 2₂₃), and the downstream-side temperature indicator 28 that measures the downstream-side temperature FGT of the flow control valves 22 (22₁ to 22₃).

Measured values obtained by these instruments are used by the control device 30 (30C to 30F) to control the opening degrees of the flow control valves 22 (22₁ to 22₃).

In the embodiment shown in FIG. 8 and FIG. 9, the opening degree command calculation part 44 (44C, 44D) of the valve opening degree setting unit 40 (40C, 40D) is configured to obtain an opening degree command FCV_{—com} that is common to the plurality of flow control valves 22 (22₁ to 22₃).

Some gasification combined cycle power plants 1 have a high maximum flow rate of a combustible gas, and therefore have the plurality of flow control valves (22₁ to 22₃) provided in parallel to one another. In this case, according to the above configuration in which a common opening degree command is given to the valves 22, the opening degrees of the plurality of flow control valves 22 (22₁ to 22₃) can be controlled by a simple technique.

However, the present invention is not limited to the configuration in which an opening degree command common to all the flow control valves 22 (22₁ to 22₃) is calculated, and may instead have a configuration in which an opening degree command common to at least two flow control valves of all the flow control valves 22 (22₁ to 22₃) is calculated.

In the illustrative embodiment shown in FIG. 8, the valve opening degree setting unit 40C includes the casing pressure calculation part 41, the pipe pressure loss calculation part 42, the outlet pressure calculation part 43, a mean differential pressure calculation part 47, the inlet pressure calculation part 45, and the opening degree command calculation part 44C.

The mean differential pressure calculation part 47 is configured to calculate a mean differential pressure value DPm of the differential pressures DP (DP₁ to DP₃) measured respectively by the differential pressure indicators 25 (25₁ to 25₃).

The inlet pressure calculation part 45 may be an adder that is configured to calculate the inlet pressure P1_{—CAL} common to the flow control valves 22 (22₁ to 22₃) by adding up the outlet pressure P2_{—CAL} calculated by the outlet pressure calculation part 43 and the mean differential pressure value DPm of the plurality of flow control valves 22 (22₁ to 22₃).

The opening degree command calculation part 44C is configured to calculate the opening degree command FCV_{—com} common to the plurality of flow control valves 22 (22₁ to 22₃) based on the fuel flow rate command CSO, and on the inlet pressure P1 and the outlet pressure P2_{—CAL}, the mean differential pressure DPm, and the downstream-side temperature FGT measured by the downstream-side temperature indicator 28, of the flow control valves (22₁ to 22₃). The opening degree command FCV_{—com} calculated by the opening degree command calculation part 44 is output to each of the flow control valves 22 (22₁ to 22₃).

According to this configuration, the plurality of control valves (22₁ to 22₃) is controlled simultaneously by using the mean differential pressure value DPm of the differential pressures DP (DP₁ to DP₃) of the plurality of flow control valves (22₁ to 22₃), which can reduce the burden of the calculation processing.

Moreover, in this configuration, if the existing differential pressure indicators 25 (25₁ to 25₃) are used, it is not necessary to provide inlet pressure indicators that measure the inlet pressures P1 (P1₁ to P1₃) of the flow control valves (22₁ to 2₂₃), so that the number of control instruments to be installed can be reduced.

In the embodiment shown in FIG. 9, the opening degree command FCV_{—com} for simultaneously controlling the plurality of flow control valves 22 (22₁ to 22₃) is obtained by using the inlet pressures P1 (P1₁ to P1₃) measured by the inlet pressure indicators 26 (26₁ to 26₃).

Specifically, the valve opening degree setting unit 40D of the control device 30D includes the casing pressure calculation part 41, the pipe pressure loss calculation part 42, the outlet pressure calculation part 43, a mean inlet pressure calculation part 48, a differential pressure calculation part 46, and the opening degree command calculation part 44D.

The mean inlet pressure calculation part 48 is configured to calculate an inlet pressure P1m that is a mean value of the inlet pressures P1 (P1₁ to P1₃) measured respectively by the inlet pressure indicators 26 (26₁ to 26₃).

The differential pressure calculation part 46 may be a difference calculator that is configured to calculate the differential pressure DP_{—CAL} of the flow control valve 22 by calculating the difference between the outlet pressure P2_{—CAL} calculated by the outlet pressure calculation part 43 and the mean inlet pressure P1m calculated by the mean inlet pressure calculation part 48.

The opening degree command calculation part 44D is configured to calculate the opening degree command FCV_{-com} common to the plurality of flow control valves 22 (22₁ to 22₃) based on the fuel flow rate command CSO, and on the inlet pressures P1 (P1₁ to P1₃) and the outlet pressure P2_{—CAL}, the differential pressure DP_{—CAL} calculated by the differential pressure calculation part 46, and the downstream-side temperature FGT measured by the downstream-side temperature indicator 28, of the flow control valves 22 (22₁ to 22₃). The opening degree command FCV_{—com} calculated by the opening degree command calculation part 44D is output to each of the flow control valves (22₁ to 22₃).

According to this configuration, the plurality of flow control valves 22 (22₁ to 22₃) is simultaneously controlled by using the inlet pressure P1m that is a mean value of the inlet pressures P1 (P1₁ to P1₃) of the plurality of flow control valves 22 (22₁ to 22₃), which can reduce the burden of the calculation processing.

Moreover, in this configuration, the inlet pressures P1 (P1₁ to P1₃) measured by the inlet pressure indicators 26 (26₁ to 26₃) are used to calculate the opening degree command FCV_{—com} for the flow control valves 22 (22₁ to 22₃), which allows for high-accuracy control of the flow control valves 22 (22₁ to 22₃).

The embodiment shown in FIG. 10 has a configuration in which the opening degree commands FCV (FCV₁ to FCV₃) for individually controlling the plurality of flow control valves 22 (22₁ to 22₃) are obtained by using the differential pressures DP (DP₁ to DP₃) measured by the differential pressure indicators 25 (25₁ to 25₃).

Specifically, the valve opening degree setting unit 40E of the control device 30E includes the casing pressure calculation part 41, the pipe pressure loss calculation parts 42 (42₁ to 42₃), the outlet pressure calculation parts 43 (43₁ to 43₃), the inlet pressure calculation parts 45 (45₁ to 45₃), an opening degree allocation calculation part 49, and the opening degree command calculation parts 44E (44E₁ to 44E₃).

The pipe pressure loss calculation parts 42 (42₁ to 42₃) calculate the pressure losses Pₗₒₛₛ_{_}_{CAL} (Pₗₒₛₛ_{_}_{CAL1} to Pₗₒₛₛ_{_}_{CAL3}) in the respective flow control valves 22 (22₁ to 22₃). In the case where the plurality of flow control valves 22 (22₁ to 22₃) is provided in the pipe 20 in parallel to one another, the pipe 20 is usually branched so as to correspond to the flow control valves 22 (22₁ to 22₃), and therefore the pressure loss in the pipe 20 including these branch pipes may be obtained.

The outlet pressure calculation parts 43 (43₁ to 43₃) may be adders that are configured to calculate the outlet pressures P2_{—CAL} (P2_{—CAL1} to P2_{—CAL3}) of the respective flow control valves 22 (22₁ to 22₃) by adding the pressure losses Pₗₒₛₛ_{_}_{CAL} (Pₗₒₛₛ_{_}_{CAL1} to Pₗₒₛₛ_{_}_{CAL3}) calculated respectively by the pipe pressure loss calculation parts 42 (42₁ to 42₃) to the casing pressure P₁ₙ_{_}_{CAL} calculated by the casing pressure calculation part 41.

The inlet pressure calculation parts 45 (45₁ to 45₃) may be adders that are configured to calculate the inlet pressures P1_{—CAL} (P1_{—CAL1} to P1_{—CAL3}) of the respective flow control valves 22 (22₁ to 22₃) by adding up the outlet pressures P2_{—CAL} (P2_{—CAL1} to P2_{—CAL3}) calculated respectively by the outlet pressure calculation parts 43 (43₁ to 43₃) and the differential pressures DP (DP₁ to DP₃) of the flow control valves 22 (22₁ to 22₃) measured respectively by the differential pressure indicators 25 (25₁ to 25₃).

The opening degree allocation calculation part 49 may be configured to allocate a common fuel flow rate to at least two flow control valves among the plurality of flow control valves (22₁ to 22₃). The specific configuration of the opening degree allocation calculation part 49 will be described later.

The opening degree command calculation parts 44E (44E₁ to 44E₃) are configured to calculate the opening degree commands for the respective flow control valves 22 (22₁ to 22₃) based on the fuel flow rates allocated to the respective valves by the opening degree allocation calculation part 49, and on the inlet pressures P1_{—CAL} (P1_{—CAL1} to P1_{—CAL3}) and the outlet pressures P2_{—CAL} (P2_{—CAL1} to P2_{—CAL3}), the differential pressures DP (DP₁ to DP₃) measured respectively by the differential pressure indicators 25 (25₁ to 2₅₃), and the downstream-side temperature FGT measured by the downstream-side temperature indicator 28, of the flow control valves 22 (22₁ to 22₃). The opening degree commands FCV (FCV₁ to FCV₃) calculated by the opening degree command calculation parts 44A to 44C are output respectively to the flow control valves (22₁ to 22₃).

According to this configuration, the plurality of flow control valves (22₁ to 22₃) is individually controlled, which allows for higher-accuracy control of each of the flow control valves (22₁ to 22₃).

Moreover, in this configuration, if the existing differential pressure indicators 25 (25₁ to 25₃) are used, it is not necessary to provide inlet pressure indicators that measure the inlet pressures of the flow control valves 22 (22₁ to 22₃), so that the number of the control instruments to be installed can be reduced.

The embodiment shown in FIG. 11 has a configuration in which the opening degree commands FCV (FCV₁ to FCV₃) for individually controlling the plurality of flow control valves 22 (22₁ to 22₃) are obtained by using the inlet pressures P1 (P1₁ to P1₃) measured by the inlet pressure indicators 26 (26₁ to 26₃).

Specifically, the valve opening degree setting unit 40F of the control device 30F includes the casing pressure calculation part 41, the pipe pressure loss calculation parts 42 (42₁ to 42₃), the outlet pressure calculation parts 43 (43₁ to 43₃), the differential pressure calculation parts 46 (46₁ to 46₃), the opening degree allocation calculation part 49, and the opening degree command calculation parts 44F (44F₁ to 44F₃).

The pipe pressure loss calculation parts 42 (42₁ to 42₃) calculate the pressure losses Pₗₒₛₛ_{_{−}}_{CAL} (Pₗₒₛₛ_{_}_{CAL1} to Pₗₒₛₛ_{_}_{CAL3}) in the respective flow control valves 22 (22₁ to 22₃). In the case where the plurality of flow control valves 22 (22₁ to 22₃) is provided in the pipe 20 in parallel to one another, the pipe 20 is usually branched so as to correspond to the flow control valves 22 (22₁ to 22₃), and therefore the pressure loss in the pipe 20 including these branch pipes may be obtained.

The outlet pressure calculation parts 43 (43₁ to 43₃) may be adders that are configured to calculate the outlet pressures P2_{—CAL} (P2_{—CAL} to P2_{—CAL3}) of the respective flow control valves 22 (22₁ to 22₃) by adding the pressure losses Pₗₒₛₛ_{_}_{CAL} (Pₗₒₛₛ_{_}_{CAL1} to Pₗₒₛₛ_{_}_{CAL3}) calculated respectively by the pipe pressure loss calculation parts 42 (42₁ to 42₃) to the casing pressure P₁ₙ_{_}_{CAL} calculated by the casing pressure calculation part 41.

The differential pressure calculation parts 46 (46₁ to 46₃) may be difference calculators that are configured to calculate the differential pressures DP_{—CAL} (DP_{—CAL1} to DP_{—CAL3}) of the respective flow control valves 22 by calculating the difference between the outlet pressures P2_{—CAL} (P2_{—CAL1} to P2_{—CAL3}) calculated respectively by the outlet pressure calculation parts 43 (43₁ to 43₃) and the inlet pressures P1 (P1₁ to P1₃) measured by the inlet pressure indicators 26 (26₁ to 26₃).

The opening degree allocation calculation part 49 may be configured to allocate a common fuel flow rate to at least two flow control valves among the plurality of flow control valves (22₁ to 22₃). The specific configuration of the opening degree allocation calculation part 49 will be described later.

The opening degree command calculation parts 44F (44F₁ to 44F₃) are configured to calculate the opening degree commands FCV (FCV₁ to FCV₃) for the respective flow control valves 22 (22₁ to 22₃) based on the fuel flow rates allocated by the opening degree allocation calculation part 49, and on the inlet pressures P1 (P₁ to P₃) and the outlet pressures P2_{—CAL} (P2_{—CAL1} to P2_{—CAL3}), the differential pressures DP_{—CAL} (DP_{—CAL1} to DP_{—CAL3}) calculated by the differential pressure calculation parts 46 (46₁ to 46₃), and the downstream-side temperature FGT measured by the downstream-side temperature indicator 28, of the flow control valves 22 (22₁ to 22₃). The opening degree commands FCV (FCV₁ to FCV₃) calculated by the opening degree command calculation parts 44F (44F₁ to 44F₃) are output to the respective flow control valves 22 (22₁ to 22₃).

According to this configuration, the plurality of flow control valves 22 (22₁ to 22₃) is individually controlled, which allows for higher-accuracy control of each of the flow control valves 22 (22₁ to 22₃).

Moreover, in this configuration, the inlet pressures P1 (P1₁ to P1₃) measured by the inlet pressure indicators 26 (26₁ to 26₃) are used to calculate the opening degree commands FCV (FCV₁ to FCV₃) for the flow control valves 22 (22₁ to 2₂₃), which allows for high-accuracy control of the flow control valves 22 (22₁ to 22₃).

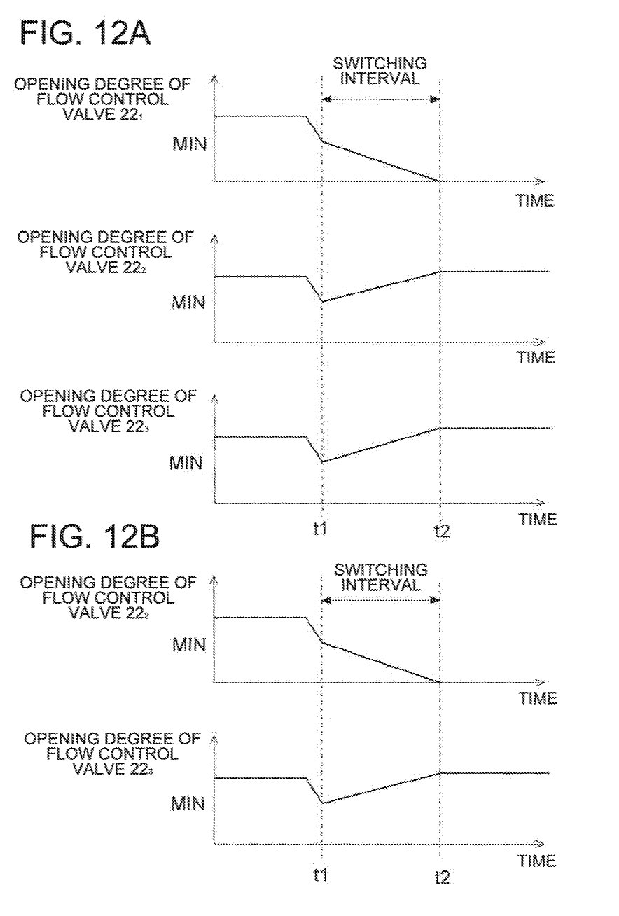

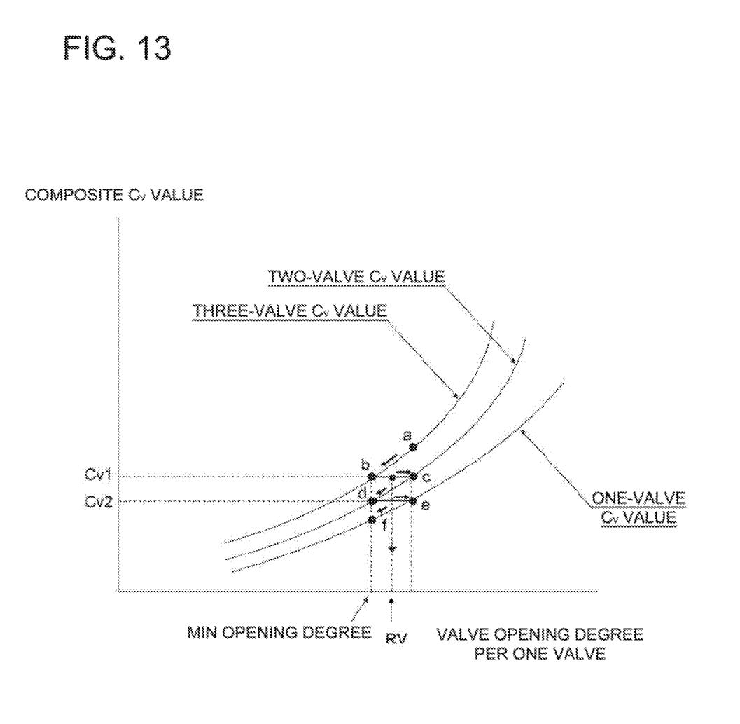

Next, details of the opening degree allocation calculation part 49 (see FIG. 10 and FIG. 11) will be described with reference to FIG. 12 and FIG. 13.

FIG. 12A is a timing chart showing opening degree control of the plurality of flow control valves (three valves) 22₁ to 22₃. FIG. 12B is a timing chart showing opening degree control of the plurality of flow control valves (two valves) 22₂, 22₃. FIG. 13 is a graph showing the characteristics of a composite Cv value of the plurality of flow control valves 22. Here, a composite Cv value refers to a total value of the Cv values (flow coefficients) of valves in the case where a plurality of valves is provided.

In some embodiments, the opening degree allocation calculation part 49 is configured to allocate the fuel flow rate (a share of opening degree) to the opening degree command calculation parts 44E₁ to 44E₃, 44F₁ to 44F₃ based on the fuel flow rate CSO (FQ).

In this case, as shown in FIG. 12A and FIG. 12B, the opening degree command calculation parts 44E₁ to 44E₃, 44F₁ to 44F₃ are configured to generate a valve closing command that causes one flow control valve (22₁) or more of the plurality of flow control valves 22 (22₁ to 22₃) to be closed, and generate, for the other flow control valves (22₂, 22₃), an opening degree command for realizing a fuel flow rate command, when the opening degree command common to the plurality of flow control valves 22 (22₁ to 22₃) reaches a minimum opening degree MIN of the flow control valves 22 (22₁ to 22₃) due to fluctuations in the operation state of the plant 1.

Thus, when the flow rate of the combustible gas supplied to the combustor 7 is low, share change control of the plurality of flow control valves 22 (22₁ to 22₃) is executed in which the flow control valves 22 (22₁ to 22₃) are switched such that at least one flow control valve (e.g., the flow control valve 22₁) is closed and that the flow rate of the combustible gas is adjusted by the other flow control valves (e.g., the flow control valves 22₂, 22₃). It is therefore possible to appropriately control each flow control valve 22 within a range not smaller than the minimum opening degree MIN so as to stabilize the combustion control of the gas turbine 10.

The opening degree allocation calculation part 49 may be configured such that the total Cv value of the plurality of valves 22 at the minimum opening degree MIN is maintained at a constant value throughout the period of a flow control valve switching interval, from the start of operation of closing at least one valve 22 (22₁) upon the opening degrees of the plurality of valves reaching the minimum opening degree MIN until full closure of this valve 22 (22₁).

Thus, combustion can be stably controlled during the period from a starting time point to an ending time point of switching of the flow control valves 22 (throughout the period of the flow control valve switching interval).

Here, the specific concept of the opening degree allocation calculation will be described with reference to FIG. 13.

In FIG. 13, when the flow rate of the fuel supplied to the flow control valves 22 that are under three-valve simultaneous control in normal operation (operation point a) varies and the three valves reach the minimum opening degree MIN (operation point b) at the same time, control of switching from the three-valve simultaneous control to two-valve simultaneous control is started. Specifically, the three-valve simultaneous control transitions to control in which a closing operation (an operation in a closing direction) of one valve and an opening operation (an operation in an opening direction) of the other two valves are performed. In this case, during the switching interval in which one valve of the three valves is closed and the other two valves are opened, the total Cv value (Cv1) of the three valves upon the three valves reaching the minimum opening degree MIN at the same time is maintained, and the fuel flow rate at that time is maintained. Thus, stable combustion control is realized even during the valve switching interval. For switching from three valves to two valves, valve switching control is continued while the total Cv value (Cv1) is maintained until one valve to be closed is fully closed. This operation is continued until an operation point c on the two-valve composite Cv value line is finally reached. This transition period is referred to as a switching interval of the flow control valves 22. The opening degrees of the other two valves that are being opened in the middle of the transition from the operation point b to the operation point c are represented by a valve opening degree (RV) corresponding to an arbitrary operation point X on the line b-c at which the total Cv value is Cv1 (RV is the point at which a dashed line drawn downward from the operation point X intersects the horizontal axis in FIG. 13).

Next, in the case of an operation state where the fuel flow rate further decreases after the operation point c is reached, the operation point moves on the two-valve total Cv value characteristic line toward an operation point d under the two-valve simultaneous control. When the fuel flow rate further decreases and the operation point d is reached, the two-valve simultaneous control is switched to one-valve control. The concept of the process of transition from the two-valve simultaneous control to the one-valve control is the same as the concept of the control between the operation point b and the operation point c under which the three-valve simultaneous control transitions to the two-valve simultaneous control. Specifically, during the period of transition from the operation point d to an operation point e, one valve transitions to a closing operation and the other valve transitions to an opening operation, while the two-valve total Cv value (Cv2) at the operation point d is maintained. The operation point e is an operation point on the one-valve Cv value characteristic line, and at this operation point e, the one valve is fully closed while the other valve reaches a valve opening degree on the one-valve Cv value characteristic line corresponding to the two-valve total Cv value (Cv2).

When the fuel flow rate further decreases after the operation point e is reached, the one-valve control is continued while the operation point moves on the one-valve Cv value characteristic line toward an operation point f When the operation point f is reached and the minimum opening degree MIN of the one valve is reached, control of switching from a combustible gas fuel to an oil fuel is executed as will be described later in detail.

The opening degree command calculation parts 44E₁ to 44E₃, 44F₁ to 44F₃ may be configured to calculate a target opening degree of the other flow control valves 22₂, 22₃ corresponding to the composite Cv value (Cv1 in FIG. 13) of the plurality of flow control valves 22 (22₁ to 22₃) at the minimum opening degree MIN, and then calculate a valve closing command FCV₁ that causes the opening degree of the at least one flow control valve 22₁ to decrease to zero at a first rate, and calculate opening degree commands FCV₂, FCV₃ that cause the opening degrees of the other flow control valves 22₂, 22₃ to increase to the target opening degree at a second rate.

For example, when all the three valves are operating, the opening degree command calculation parts 44E₁ to 44E₃, 44F₁ to 44F₃ calculate the valve opening degree command FCV_{—com} that is common to the flow control valves 22 (22₁ to 22₃) by using the relationship between the three-valve composite Cv value and the valve opening degree shown in FIG. 13. When the plurality of flow control valves 22 (22₁ to 22₃) reach the minimum opening degree MIN as the operation state of the plant 1 changes, these opening degree command calculation parts calculate the valve opening command FCV₁ that causes the opening degree of the one flow control valve 22₁ to decrease to zero. Meanwhile, for the other flow control valves 22₂, 22₃, these opening degree command calculation parts calculate the target opening degree of the two flow control valves 22₂, 22₃ (i.e., the valve opening degree corresponding to the operation point c (see FIG. 13) for realizing Cv1 by the two valves), based on Cv1 that is the three-valve composite Cv value at a time point t1 of the minimum opening degree MIN by using the relationship between the two-valve composite Cv value and the valve opening degree, and calculate the opening degree command for the two flow control valves 22₂, 22₃ such that the target opening degree is met.

Thus, in the case where the flow rate of the combustible gas supplied to the combustor 7 is low, and the share change control of the plurality of flow control valves 22 (22₁ to 22₃) is executed in which the flow control valves 22 (22₁ to 22₃) are switched such that at least one flow control valve (e.g., the flow control valve 22₁) is closed and that the flow rate of the combustible gas is adjusted by the other flow control valves (e.g., the flow control valves 22₂, 22₃), the composite Cv value can be maintained between before and after the share change control. As a result, the influence of the share change control of the flow control valves 22 on the flow rate of the combustible gas supplied to the combustor 7 can be reduced.

In this case, the first rate and the second rate may be set such that a time point t2 at which the opening degree of the at least one flow control valve 22₁ reaches zero and a time point at which the opening degrees of the other flow control valves 22₂, 22₃ reach the target opening degree coincide with each other.

Thus, it is possible to suppress fluctuations in the composite Cv value during the share change control of the flow control valves 22, and thereby to stably adjust the flow rate of the combustible gas supplied to the combustor 7.

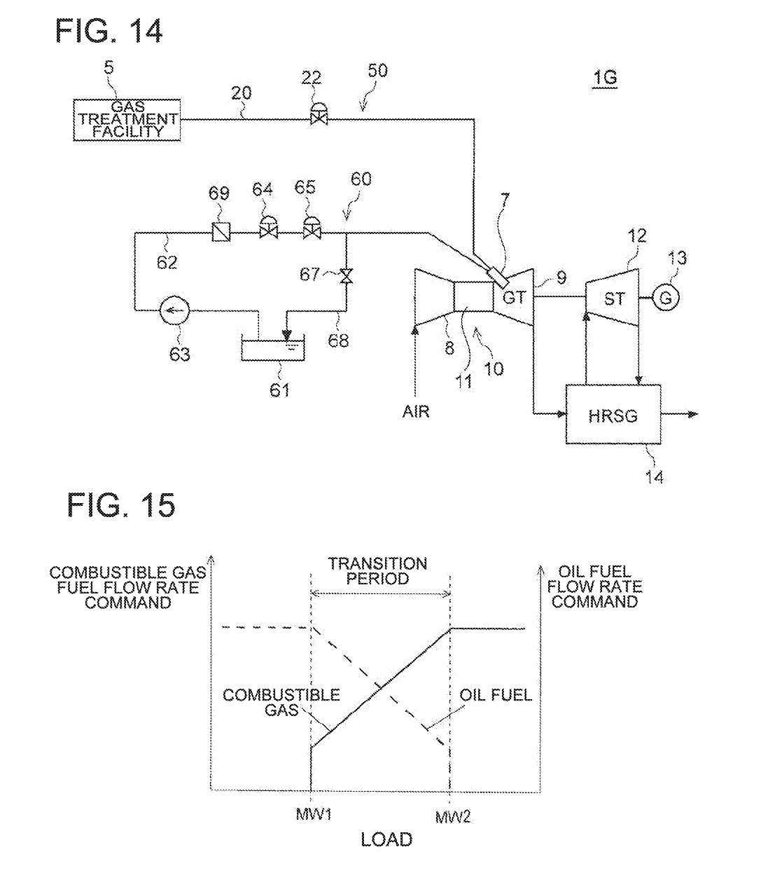

FIG. 14 is a configuration view showing a fuel supply system according to yet another embodiment. In the embodiment to be described below with reference to FIG. 14, control of switching from a combustible gas fuel to an oil fuel is executed in place of or in addition to the above embodiment related to the share change control for a combustible gas fuel.

In the embodiment shown in FIG. 14, a gasification combined cycle power plant 1G includes a combustible gas supply system 50 that supplies a combustible gas to the combustor 7 of the gas turbine 10, and an oil supply system 60 that supplies an oil fuel to the combustor 7 of the gas turbine 10.

This gasification combined cycle power plant 1 is configured so as to be able to switch fuels between an oil fuel and a combustible gas. For example, in a low-load operation region such as during startup, the oil fuel is supplied to the combustor 7 by the oil supply system 60, and in a high-load operation region such as during steady operation, the combustible gas is supplied to the combustor 7 by the combustible gas supply system 50.

Specifically, the oil supply system 60 includes: an oil supply pipe 62 through which the oil fuel is supplied from an oil tank 61 to the combustor 7; a pump 63 that pumps the oil fuel; a filter 69 that removes impurities from the oil fuel; a pressure control valve 64 and a flow control valve 65 provided in the oil supply pipe 62; and a bypass pipe 68 and a bypass valve 67 through which the oil fuel is discharged from between the flow control valve 65 and the combustor 7 and pressure is released.

The gasification furnace 3 and the peripheral configuration are the same as in FIG. 1, and therefore these are omitted from FIG. 14.

In this configuration, the combustible gas supply system 50 and the oil supply system 60 are switchable.

In the gasification combined cycle power plant 1 thus configured, the opening degree command calculation parts 44A to 44F are configured to obtain an opening degree command for the flow control valve 22 based on a fuel flow rate command indicating the flow rate of the combustible gas to be supplied to the combustor 7.

FIG. 15 is a graph showing an example of relationships of a combustible gas fuel flow rate command and an oil fuel flow rate command to the load during fuel switching.

As shown in FIG. 15, during fuel switching, the combustible gas fuel flow rate command indicating the flow rate of the combustible gas and the oil fuel flow rate command indicating the flow rate of the oil fuel are gradually switched between a load MW1 and a load MW2. For example, in the low-load operation region such as during startup or before shutdown, the gas turbine 10 is driven mainly with the oil fuel, while in the high-load operation region such as during rated operation, the gas turbine 10 is driven mainly with the combustible gas. Thus, the transition period between the low-load operation region and the high-load operation region constitutes a switching region in which the oil fuel flow rate command and the combustible gas fuel flow rate command are switched.

In this case, the opening degree command calculation parts 44A to 44F calculate the opening degree command for the flow control valve 22 in the combustible gas supply system 50 so as to respond to increases and decreases in the combustible gas fuel flow rate command as shown in FIG. 15.

According to this configuration, the opening degree of the flow control valve 22 can be appropriately controlled based on the fuel flow rate command indicating the flow rate of the combustible gas to be supplied to the combustor 7. In particular, since the opening degree command for the flow control valve 22 is obtained as described above based on the fuel flow rate command CSO for the gas turbine 10, the calculation result P2_{—CAL} of the outlet pressure of the flow control valve 22, and the measured value DP of the differential pressure of the flow control valve 22 or the measured value P1 of the inlet pressure of the flow control valve 22, even when a pressure control valve is omitted from the fuel supply pipe 20 of the gas turbine 10, the opening degree of the flow control valve 22 can be controlled with high accuracy with the pressure loss in the pipe from the flow control valve 22 to the combustor 7 taken into account.

In the share change control of the combustible gas fuel described above, the fuel may be switched from the combustible gas fuel to the oil fuel when the minimum opening degree MIN is reached during the one-valve control. Specifically, in FIG. 13, when the operation point f at which the valve opening degree of one valve is the minimum opening degree MIN is reached, as shown in FIG. 15, the flow control valve 65 for the oil fuel transitions to an opening operation and the flow control valve 22 for the combustible gas fuel transitions to a closing operation, while the fuel flow rate command value corresponding to the minimum Cv value of the flow control valve 22 is maintained at the load MW2. When the load MW1 at which the flow control valve 22 is fully closed is reached, the flow control valve 65 for the oil fuel reaches a valve opening degree at which the fuel command value at the load MW2 is maintained. In the fuel switching region that corresponds to this transition period, the valves are switched while the fuel flow rate at the load MW2 is maintained.

As has been described above, according to at least some embodiments of the present invention, the opening degree of the flow control valve 22 can be controlled with the pressure loss in the pipe 20 from the flow control valve 22 to the combustor 7 taken into account, which allows for high-accuracy control. Thus, even when a pressure control valve is omitted from the fuel supply pipe 20 of the gas turbine 10, fuel can be supplied at a desired flow rate to the combustor 7. Moreover, even when the fuel flow rate of the combustible gas fuel decreases, the combustible gas fuel is smoothly switched to the oil fuel, and thus stable combustion control is realized.

In a typical gasification combined cycle power plant, the gas turbine may be actuated by using a startup fuel, such as an oil fuel, during startup of the plant until a combustible gas is generated in the gasification furnace. In this case, the inlet temperature of the gas turbine or the combustion state in the combustor of the gas turbine may be affected by fluctuations in the fuel ratio of the combustible gas to the total fuel due to the difference in calorific value between the startup fuel and the combustible gas. This problem is not limited to during startup of a gasification combined cycle power plant, but can also arise when fuels are switched between the combustible gas generated in the gasification furnace and another fuel that has a higher calorie than the combustible gas.

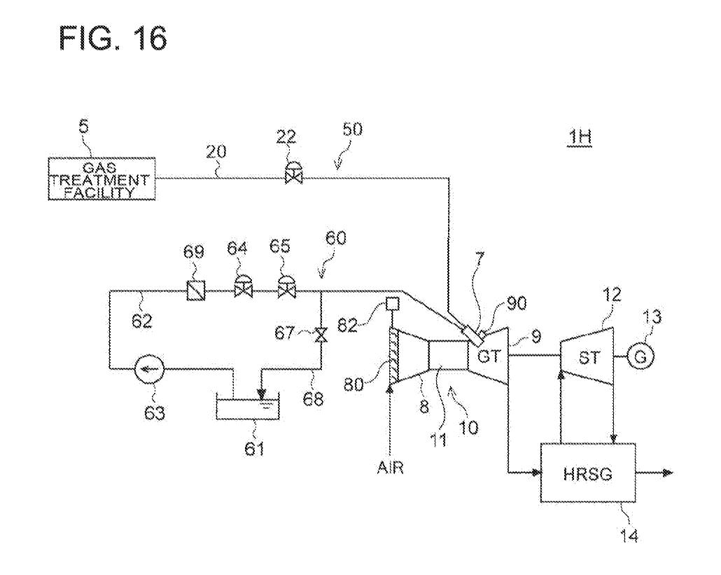

In some embodiments, therefore, IGV opening degree control to be described below with reference to FIG. 16 to FIG. 20 is executed with the objective of maintaining the gas turbine inlet temperature within an appropriate range and maintaining combustion stability during fuel switching of a gasification combined cycle power plant.

In the embodiments described below with reference to FIG. 16 to FIG. 20, the opening degree of the IGV is controlled during fuel switching, in place of or in addition to the above embodiment related to the opening degree control of the flow control valve 22 by the valve opening degree setting unit 40.

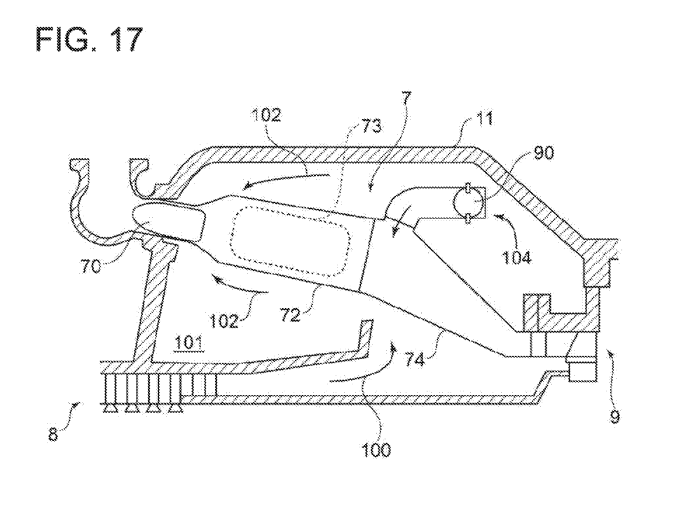

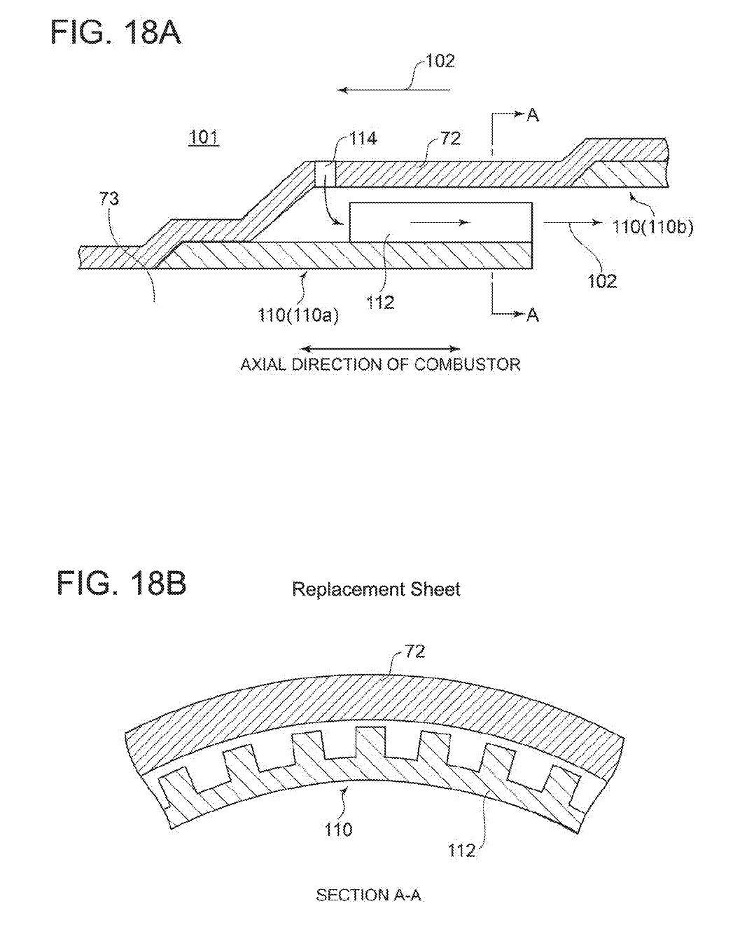

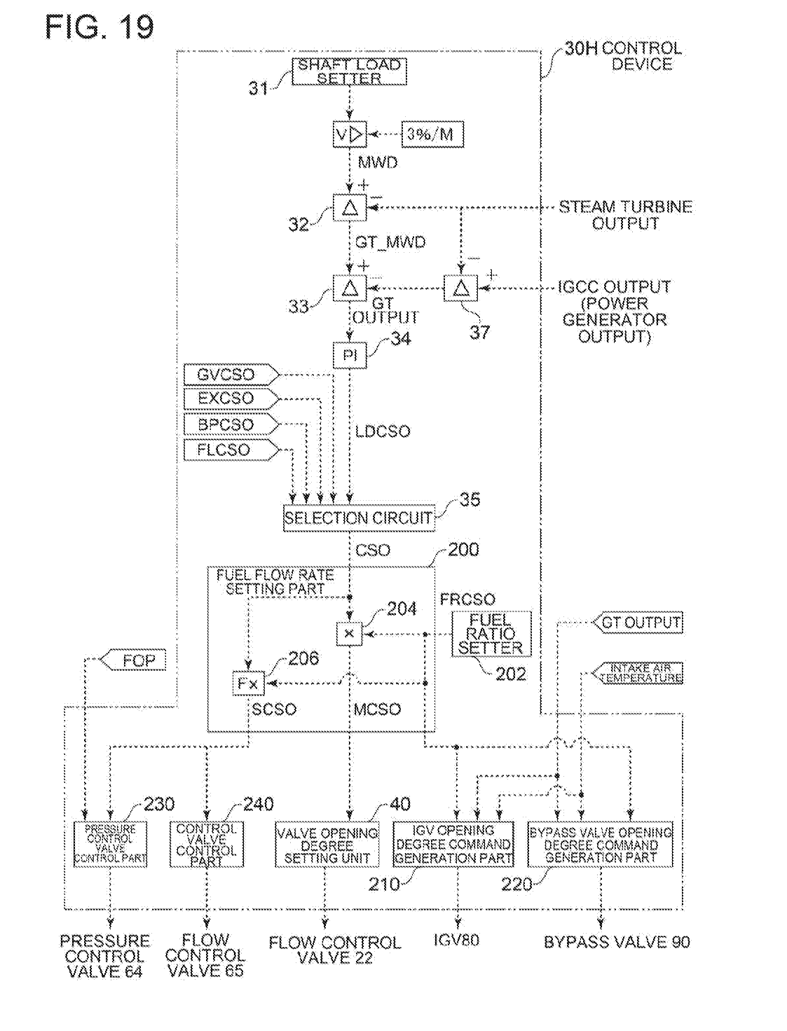

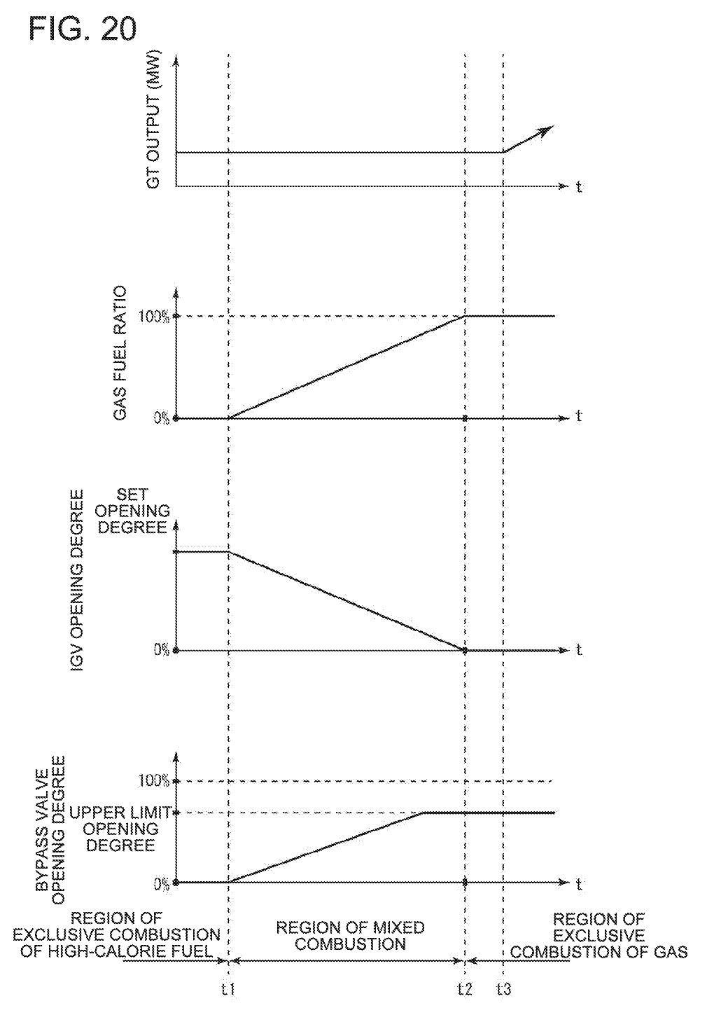

FIG. 16 is a view showing the configuration of a gasification combined cycle power plant according to an embodiment. FIG. 17 is a view showing an example of the configuration of a bypass valve of a gas turbine. FIG. 18 is a view showing an example of the configuration of a combustion liner, in which FIG. 18(a) is a sectional view of the combustion liner along an axial direction of the combustor, and FIG. 18(b) is a view showing section A-A in FIG. 18(a). FIG. 19 is a block diagram showing the configuration of a control device of a gasification combined cycle power plant according to an embodiment. FIG. 20 is a timing chart showing opening degree control of the IGV and the bypass valve during fuel switching according to an embodiment.

As shown in FIG. 16, a gasification combined cycle power plant 1H is configured to be able to switch the fuel to be combusted in the combustor 7, between a combustible gas that is supplied from the gas treatment facility 5 through the combustible gas supply system 50 and an oil fuel that is supplied through the oil supply system 60. In the illustrative embodiment shown in FIG. 16, fuels are switched between the combustible gas and the oil fuel. However, instead of the oil fuel, an arbitrary fuel having a higher calorific value than the combustible gas (the oil fuel and other arbitrary fuels will be hereinafter collectively referred to as a “high-calorie fuel”) may be used.

Like the gasification combined cycle power plant 1G described above using FIG. 14, the gasification combined cycle power plant 1H includes the flow control valve 65 that adjusts the flow rate of the high-calorie fuel, and the pressure control valve 64 that is provided on the upstream side of the flow control valve 65. Thus, the flow rate of the high-calorie fuel supplied to the combustor 7 can be adjusted by the opening degree control of the flow control valve 64, while the pressure on the upstream side of the flow control valve 65 can be maintained within an appropriate range by the opening degree control of the pressure control valve 64. In FIG. 16, those components that are common with the gasification combined cycle power plant 1G are denoted by the same reference signs and detailed description of these components will be omitted.

In some embodiments, as shown in FIG. 16, the gasification combined cycle power plant 1H includes an IGV (inlet guide vane) 80 that adjusts the amount of air flowing into the compressor 8 of the gas turbine 10, and an air bypass valve 90 provided in the combustor 7.

The IGV 80 is configured to be turned by an actuator 82. The opening degree of the IGV 80 can be adjusted to an arbitrary degree between a minimum value (0% opening degree) and a maximum value (100% opening degree) by adjusting the vane angle of the IGV 80 relative to an air current by the actuator 82. When the opening degree of the IGV 80 is reduced, the amount of air flowing into the compressor 8 decreases, and when the opening degree of the IGV 80 is increased, the amount of air flowing into the compressor 8 increases.

As shown in FIG. 17, the air bypass valve 90 is configured to adjust the amount of compressed air that bypasses a combustion region 73 formed in a combustion liner (combustor basket) 72 of the combustor 7. Specifically, in the gas turbine 10, compressed air 100 generated in the compressor 8 is supplied to the combustor 7 through an internal space 101 of the casing 11 of the gas turbine 10. Here, when the air bypass valve 90 is in an open state, only combustion air (see reference sign 102) that is part of the compressed air 100 is supplied to the combustion liner 72 (combustion nozzle 70) of the combustor 7, while bypass air (see reference sign 104) that is the rest of the compressed air 100 is supplied to the downstream side of the combustion region 73 of the combustor 7. The air bypass valve 90 is configured such that the opening degree thereof can be controlled by an actuator (not shown), and the opening degree of the air bypass valve 90 can be adjusted to an arbitrary degree between the minimum value (0% opening degree) and the maximum value (100% opening degree). When the opening degree of the air bypass valve 90 is reduced, the amount of air bypassing the combustion region 73 (the flow rate of the bypass air 104) decreases, and when the opening degree of the air bypass valve 90 is increased, the amount of air bypassing the combustion region 73 (the flow rate of the bypass air 104) increases.

In the example shown in FIG. 17, the combustor 7 includes the combustor nozzle 70 that injects fuel into the combustion liner 72, and a transition piece 74 that guides combustion gas from the combustion liner 72 to the inlet of the turbine 9. The air bypass valve 90 may be connected to the transition piece 74.

As shown in FIGS. 18(a) and 18(b), the combustor 7 includes a fin ring 110 that is provided on the inner circumferential side of the combustion liner 72. The fin ring 110 has a plurality of fins 112 in a circumferential direction, with each fin 112 extending along the axial direction of the combustor 7. A plurality of fin rings 110 is provided in the axial direction of the combustor 7, and the inside diameter of a fin ring 110b located on the downstream side is larger than the outside diameter of a fin ring 110a located on the upstream side. On the other hand, the combustion liner 72 is provided with a cooling air hole 114, and part of the compressed air 102 (cooling air) is introduced from the internal space 101 of the casing 11 through the cooling air hole 114 into the combustion liner 72. The cooling air introduced into the combustion liner 72 flows between the fins 112 of the fin ring 110a toward the downstream side along the axial direction of the combustor 7, and thereby performs film-cooling on an inner wall surface of the combustion liner 72 (more specifically, an inner wall surface of the other fin ring 110b located on the downstream side).

In the gasification combined cycle power plant 1H, under control executed by a control device 30H shown in FIG. 19, the opening degrees of the IGV 80 and the air bypass valve 90 are controlled according to the fuel ratio of the combustible gas to the total fuel during fuel switching between the combustible gas and the high-calorie fuel.

As shown in FIG. 18, the control device 30H has the basic configuration in common with the control device 30 having been described with reference to FIG. 2. Those components of the control device 30H that execute signal processing up to the selection circuit 35 will be denoted by the same reference signs as in the control device 30 and description thereof will be omitted here.

The control device 30H includes a fuel flow rate setting part 200 that sets a fuel flow rate command for each of the combustible gas and the high-calorie fuel based on the fuel flow rate command CSO output from the selection circuit 35. The fuel flow rate setting part 200 has a multiplier 204 and a function 206. The multiplier 204 calculates a fuel flow rate command MCSO for the combustible gas by multiplying a gas fuel ratio FRCSO (=a ratio of the combustible gas to the total fuel) set by a fuel ratio setter 202 and the fuel flow rate command CSO. On the other hand, the function 206 calculates a high-calorie fuel flow rate command SCSO from the fuel flow rate command CSO based on the gas fuel ratio FRCSO set by the fuel ratio setter 202. Specifically, the function 206 calculates the high-calorie fuel flow rate command SCSO by substituting the gas fuel ratio FRCSO and the fuel flow rate command CSO into the following Formula (2):

SCSO=CSO×(100%−FRCSO [%])/100% (2)

The control device 30H includes an IGV opening degree command generation part 210 and a bypass valve opening degree command generation part 220 that calculate the opening degree command values for the IGV 80 and the air bypass valve 90, respectively, based on the gas fuel ratio FRCSO set by the fuel ratio setter 202.

During fuel switching between the combustible gas and the high-calorie fuel, the IGV opening degree command generation part 210 reduces the opening degree command value for the IGV 80 toward the closing side (0% opening degree), and thereby reduces the amount of air flowing into the compressor 8, as the fuel ratio FRCSO of the combustible gas to the total fuel increases. Conversely, the IGV opening degree command generation part 210 increases the opening degree command value for the IGV 80 toward the opening side (100% opening degree), and thereby increases the amount of air flowing into the compressor 8, as the fuel ratio FRCSO of the combustible gas to the total fuel decreases.

The IGV opening degree command generation part 210 reduces the opening degree of the IGV 80 as the fuel ratio FRCSO of the combustible gas increases, which makes it possible to avoid a decrease in the inlet temperature of the turbine 9 associated with the use of the low-calorie combustible gas, and at the same time to improve the combustion stability in the combustor 7 during fuel switching from the high-calorie fuel to the combustible gas.

In some embodiments, the IGV opening degree command generation part 210 is configured to generate an opening degree command value (0% opening degree) that causes the IGV 80 to be fully closed, when the fuel ratio FRCSO of the combustible gas is 100% (during exclusive combustion of the combustible gas). Thus setting the opening degree of the IGV 80 to full closure during exclusive combustion of the combustible gas can secure a wide range of adjustment of the amount of air through the adjustment of the opening degree of the IGV 80 according to the fuel ratio FRCSO of the combustible gas. On the other hand, when the fuel ratio FRCSO of the combustible gas is 0% (during exclusive combustion of the high-calorie fuel), the IGV opening degree command generation part 210 outputs an opening degree command value that is set for exclusive combustion of the high-calorie fuel. The opening degree command value for the IGV 80 for exclusive combustion may be a value larger than the minimum opening degree (0% opening degree) but smaller than the maximum opening degree (100% opening degree).

In the illustrative embodiment shown in FIG. 19, the IGV opening degree command generation part 210 corrects the opening degree command value according to the output of the gas turbine 10 and to the intake air temperature on the inlet side of the compressor 8, and outputs the corrected opening degree command value.

During fuel switching between the combustible gas and the high-calorie fuel, the bypass valve opening degree command generation part 220 increases the opening degree command value for the air bypass valve 90 toward the opening side (100% opening degree), and thereby reduces the amount of air supplied to the combustion region 73 of the combustor 7, as the fuel ratio FRCSO of the combustible gas to the total fuel increases. Conversely, the bypass valve opening degree command generation part 220 reduces the opening degree command value for the air bypass valve 90 toward the closing side (0% opening degree), and thereby increases the amount of air supplied to the combustion region 73 of the combustor 7, as the fuel ratio FRCSO of the combustible gas to the total fuel decreases.

The bypass valve opening degree command generation part 220 increases the opening degree of the air bypass valve 90 as the fuel ratio FRCSO of the combustible gas increases, which makes it possible to avoid a decrease in the temperature of the combustion region 73 and at the same time to improve the combustion stability in the combustor 7 during fuel switching from the high-calorie fuel to the combustible gas.

In some embodiments, when the fuel ratio FRCSO of the combustible gas is 100% (during exclusive combustion of the combustible gas), the bypass valve opening degree command generation part 220 sets the opening degree command value for the air bypass valve 90 to an upper limit opening degree that can secure a required amount of film air (or a required flow velocity of the film air) at the outlet of the fin ring 110. Thus, the opening degree command value for the air bypass valve 90 during exclusive combustion of the combustible gas is set to the upper limit opening degree determined by the amount (or the flow velocity) of film air. This makes it possible to effectively cool the combustion liner 72 of the combustor 7, and yet reduce the amount of air supplied to the combustion region 73 of the combustor 7 so as to avoid a decrease in the temperature of the combustion region 73 and improve the combustion stability in the combustor 7. On the other hand, when the fuel ratio FRCSO of the combustible gas is 0% (during exclusive combustion of the high-calorie fuel), the bypass valve opening degree command generation part 220 may set the opening degree of the air bypass valve 90 to full closure (0% opening degree).

In the illustrative embodiment shown in FIG. 19, the bypass valve opening degree command generation part 220 corrects the opening degree command value according to the output of the gas turbine 10 and to the intake air temperature on the inlet side of the compressor 8, and outputs the corrected opening degree command value.

In some embodiments, as shown in FIG. 19, the control device 30H may further include the valve opening degree setting unit 40 (40A to 40F) of the above embodiment, and a pressure control valve control part 230 and a flow control valve control part 240 that control the opening degrees of the pressure control valve 64 and the flow control valve 65, respectively, of the gasification combined cycle power plant 1H.

In the illustrative embodiment shown in FIG. 19, the valve opening degree setting unit 40 (40A to 40F) calculates the valve opening degree command for the flow control valve 22 by the above technique, from the fuel flow rate command MCSO for the combustible gas output from the fuel flow rate setting part 200. The calculation method of the valve opening degree command for the flow control valve 22 used by the valve opening degree setting unit 40 (40A to 40F) has already been described above and therefore description thereof will be omitted here.

The pressure control valve control part 230 generates an opening degree command for the pressure control valve 64, from the fuel flow rate command SCSO for the high-calorie fuel output from the fuel flow rate setting part 200 and based on a detection result of a fuel supply pressure (FOP) in the high-calorie fuel supply system 60. Similarly, the flow control valve control part 240 generates an opening degree command for the flow control valve 65 from the fuel flow rate command SCSO for the high-calorie fuel output from the fuel flow rate setting part 200.

The functions of the valve opening degree setting unit 40, the pressure control valve control part 230, and the flow control valve control part 240 allow the flow control valves (22, 65) and the pressure control valve 64 to be appropriately controlled during fuel switching between the combustible gas and the high-calorie fuel, according to the fuel ratio FRCSO of the combustible gas set by the fuel ratio setter 202.

An example of opening degree control of the IGV 80 and the air bypass valve 90 by the control device 30H having the above configuration will be described.

FIG. 20 shows the opening degree control of the IGV 80 and the air bypass valve 90 in a case where fuel switching from the high-calorie fuel (e.g., an oil fuel) to the combustible gas is performed during startup of the gasification combined cycle power plant 1H.

As shown in FIG. 20, the fuel ratio setter 202 of the control device 30H increases the gas fuel ratio FRCSO from 0% to 100% over the period from time t₁ to time t₂. In this case, problems such as a decrease in the inlet temperature of the turbine 9 and instable combustion in the combustor 7 due to an increase in the fuel ratio FRCSO of the combustible gas are more likely to occur than during exclusive combustion of the high-calorie fuel before time t₁. Therefore, the IGV opening degree command generation part 210 of the control device 30H reduces the opening degree command value for the IGV 80 over the period from time t₁ to time t₂, from the set opening degree during exclusive combustion of the high-calorie fuel to full closure (0% opening degree), as the gas fuel ratio FRCSO increases. Meanwhile, the bypass valve opening degree command generation part 220 of the control device 30H increases the opening degree command value for the air bypass valve 90 over the period from time t₁ to time t₂, from full closure (0% opening degree) to the upper limit opening degree that can secure the required amount (or the required flow rate) of film cooling in the combustion liner 72, as the gas fuel ratio FRCSO increases.

Time t₃ in FIG. 20 is the ending time of purging of the high-calorie fuel that is started from the time point (time t₂) at which fuel switching from the high-calorie fuel to the combustible gas is completed. Here, purging refers to a cleansing treatment in which a purging fluid, such as air or water, is circulated through a high-calorie fuel flow passage of the combustor nozzle 70 of the combustor 7 to thereby prevent solids of the high-calorie fuel accumulated inside the combustor nozzle 70 from blocking the flow passage.

In the illustrative embodiment shown in FIG. 20, during startup of the gasification combined cycle power plant 1H, a constant output of the gas turbine 10 is maintained during the period from time t₁ at which fuel switching starts until time t₃ at which purging ends. After time t₃ at which purging ends, the output of the gas turbine 10 increases toward the rated output under the control by the control device 30H.

The present invention is not limited to the above embodiments but also includes embodiments that are modified from the above embodiments or combine the above embodiments.

Terms representing relative or absolute arrangement, for example, “in a direction,” “along a direction,” “parallel,” “orthogonal,” “center,” “concentrically,” and “coaxially,” are intended to represent not only exactly such arrangement but also a state where there is a relative shift within tolerance, or by an angle or distance to such an extent that the same function can be obtained.

Terms representing a state where things are equal, for example, “the same,” “equal,” and “equivalent,” are intended to represent not only an exactly equal state but also a state where there is a difference within tolerance or to such an extent that the same function can be obtained.

Terms representing shapes such as a quadrangular shape and a cylindrical shape are intended to represent not only shapes such as a quadrangular shape and a cylindrical shape in a geometrically exact sense but also shapes including a recess and a protrusion, a chamfered portion, etc. to such an extent that the same effect can be achieved.

On the other hand, terms “including,” “containing,” or “having” one component are not exclusive terms that eliminate the possibility of the presence of other components.

### REFERENCE SIGNS LIST

1 Gasification combined cycle power plant
3 Gasification furnace
5 Gas treatment facility
6 Power generation facility
7 Combustor
8 Compressor
9 Turbine
10 Gas turbine
12 Steam turbine
13 Power generator
15 Heat recovery steam generator
20 Pipe
22 Flow control valve
24 Intake air temperature indicator
25 Differential pressure indicator
26 Inlet pressure indicator
27 Downstream-side pressure indicator
28 Downstream-side temperature indicator
30 Control device
40 Valve opening degree setting unit
41 Casing pressure calculation part
42 Pipe pressure loss calculation part
43 Outlet pressure calculation part
44 Opening degree command calculation part
45 Inlet pressure calculation part
46 Differential pressure calculation part
47 Mean differential pressure calculation part
48 Mean inlet pressure calculation part
49 Opening degree allocation calculation part
50 Combustible gas supply system
60 Oil supply system
70 Combustor nozzle
72 Combustion liner
73 Combustion region
74 Transition piece
82 Actuator
90 Air bypass valve
110 Fin ring
112 Fin
114 Cooling air hole
200 Fuel flow rate setting part
202 Fuel ratio setter
204 Multiplier
206 Function
210 Opening degree command generation part
220 Bypass valve opening degree command generation part
230 Pressure control valve control part
240 Control valve control part

1. A control device of a gasification combined cycle power plant including a gasification furnace, a gas turbine configured to be driven with a combustible gas generated in the gasification furnace as fuel, and a flow control valve provided in a pipe through which the combustible gas is supplied from the gasification furnace to the gas turbine, the control device comprising:
a casing pressure calculation part that calculates a casing pressure of the gas turbine;
a pipe pressure loss calculation part that calculates a pressure loss in the pipe from the flow control valve to a combustor of the gas turbine;
an outlet pressure calculation part that calculates an outlet pressure of the flow control valve based on the casing pressure calculated by the casing pressure calculation part and the pressure loss calculated by the pipe pressure loss calculation part; and
an opening degree command calculation part configured to obtain an opening degree command for the flow control valve based on a fuel flow rate command for the gas turbine, a calculation result of the outlet pressure obtained by the outlet pressure calculation part, and a measured value of a differential pressure of the flow control valve or of an inlet pressure of the flow control valve.

2. The control device of a gasification combined cycle power plant according to claim 1, wherein the opening degree command calculation part is configured to obtain the opening degree command based on a measured value of a temperature on a downstream side of the flow control valve.

3. The control device of a gasification combined cycle power plant according to claim 1, wherein the casing pressure calculation part is configured to calculate the casing pressure based on the fuel flow rate command, an IGV opening degree of a compressor of the gas turbine, and an intake air temperature of the compressor.

4. The control device of a gasification combined cycle power plant according to claim 1, wherein the pipe pressure loss calculation part is configured to calculate the pressure loss based on a flow rate of the combustible gas flowing through the flow control valve, a pressure on a downstream side of the flow control valve, and a temperature on the downstream side of the flow control valve.

5. The control device of a gasification combined cycle power plant according to claim 1, wherein:
a plurality of flow control valves is provided in the pipe in parallel to one another; and
the opening degree command calculation part is configured to obtain the opening degree command that is common to the plurality of flow control valves.

6. The control device of a gasification combined cycle power plant according to claim 5, wherein the opening degree command calculation part is configured to generate a valve closing command that causes at least one of the plurality of flow control valves to be closed, and generate, for the other flow control valves, an opening degree command for realizing the fuel flow rate command, when the opening degree command common to the plurality of flow control valves reaches a minimum opening degree of the flow control valves.

7. The control device of a gasification combined cycle power plant according to claim 5, wherein the opening degree command calculation part is configured to obtain the opening degree command common to the plurality of flow control valves such that a total flow coefficient of the flow control valves upon reaching the minimum opening degree is maintained during switching of the valves.

8. The control device of a gasification combined cycle power plant according to claim 6, wherein the opening degree command calculation part is configured to:
calculate a target opening degree of the other flow control valves corresponding to a composite Cv value of the plurality of flow control valves at the minimum opening degree;
calculate the valve closing command that causes the opening degree of the at least one flow control valve to decrease to zero at a first rate; and
calculate the opening degree command that causes the opening degrees of the other flow control valves to increase to the target opening degree at a second rate.

9. The control device of a gasification combined cycle power plant according to claim 8, wherein the first rate and the second rate are set such that a time point at which the opening degree of the at least one flow control valve reaches zero and a time point at which the opening degrees of the other flow control valves reach the target opening degree coincide with each other.

10. The control device of a gasification combined cycle power plant according to claim 1, wherein:
the gasification combined cycle power plant further includes an oil supply pipe through which an oil fuel is supplied to the combustor of the gas turbine, and is configured to be able to switch fuels between the combustible gas from the pipe and the oil fuel from the oil supply pipe; and
the gasification combined cycle power plant is configured to switch from the combustible gas to the oil fuel when, for each of the flow control valves, the opening degree command for realizing the fuel flow rate command reaches a minimum opening degree of the flow control valve.

11. A control device of a gasification combined cycle power plant including a gasification furnace, a gas turbine that is driven with a combustible gas generated in the gasification furnace as fuel, and a plurality of flow control valves provided in parallel to one another in a pipe through which the combustible gas is supplied from the gasification furnace to the gas turbine,
the control device comprising an opening degree command calculation part that calculates an opening degree command for each of the plurality of flow control valves,
wherein the opening degree command calculation part is configured to:
obtain the opening degree command that is common to the plurality of flow control valves; and
generate a valve closing command that causes at least one of the plurality of flow control valves to be closed, and generate, for the other flow control valves, an opening degree command for realizing a fuel flow rate command for the gas turbine, when the opening degree command common to the plurality of flow control valves reaches a minimum opening degree of the flow control valves.

12. The control device of a gasification combined cycle power plant according to claim 1, further comprising an IGV opening degree command generation part that generates an opening degree command value for an IGV of a compressor of the gas turbine, wherein the IGV opening degree command generation part is configured to reduce the opening degree command value for the IGV toward a closing side as a fuel ratio of the combustible gas to a total fuel increases, during fuel switching of the gasification combined cycle power plant between the combustible gas and another fuel having a higher calorific value than the combustible gas.

13. The control device of a gasification combined cycle power plant according to claim 1, further comprising an air bypass valve opening degree command generation part that generates an opening degree command value for an air bypass valve that adjusts an amount of compressed air that is part of compressed air generated in a compressor of the gas turbine and bypasses a combustion region of a combustor of the gas turbine, wherein the control device is configured to increase the opening degree command value for the air bypass valve toward an opening side as a fuel ratio of the combustible gas to a total fuel increases, during fuel switching of the gasification combined cycle power plant between the combustible gas and another fuel having a higher calorific value than the combustible gas.

14. A control device of a gasification combined cycle power plant including a gasification furnace, and a gas turbine configured to be driven with a combustible gas generated in the gasification furnace as fuel,
the control device comprising an IGV opening degree command generation part that generates an opening degree command value for an IGV of a compressor of the gas turbine,
wherein the IGV opening degree command generation part is configured to reduce the opening degree command value for the IGV toward a closing side as a fuel ratio of the combustible gas to a total fuel increases, during fuel switching of the gasification combined cycle power plant between the combustible gas and another fuel having a higher calorific value than the combustible gas.

15. The control device of a gasification combined cycle power plant according to claim 14, wherein the IGV opening degree command generation part is configured to reduce the opening degree command value for the IGV toward the closing side as the fuel ratio of the combustible gas increases, during fuel switching from the other fuel to the combustible gas at startup of the gasification combined cycle power plant.

16. The control device of a gasification combined cycle power plant according to claim 14, wherein the IGV opening degree command generation part is configured to generate the opening degree command value that causes the IGV to be fully closed, when the fuel ratio of the combustible gas is 100%.

17. A gasification combined cycle power plant comprising:
a gasification furnace;
a gas turbine that is driven with a combustible gas generated in the gasification furnace as fuel;
a flow control valve that is provided in a pipe through which the combustible gas is supplied from the gasification furnace to the gas turbine; and
the control device according to claim 1 that is configured to control the flow control valve.

18. A control method of a gasification combined cycle power plant including a gasification furnace, a gas turbine to be driven with a combustible gas generated in the gasification furnace as fuel, and a flow control valve that is provided in a pipe through which the combustible gas is supplied from the gasification furnace to the gas turbine, the control method comprising the steps of:
calculating a casing pressure of the gas turbine;
calculating a pressure loss in the pipe from the flow control valve to a combustor of the gas turbine;
calculating an outlet pressure of the flow control valve based on a calculation result of the casing pressure and a calculation result of the pressure loss; and
obtaining an opening degree command for the flow control valve based on a fuel flow rate command for the gas turbine, a calculation result of the outlet pressure, and a measured value of a differential pressure of the flow control valve or of an inlet pressure of the flow control valve

19. A control method of a gasification combined cycle power plant including a gasification furnace, and a gas turbine to be driven with a combustible gas generated in the gasification furnace as fuel,
the control method comprising a step of generating an opening degree command value for an IGV of a compressor of the gas turbine,
wherein, in the step of generating the opening degree command value for the IGV, the opening degree command value for the IGV is reduced toward a closing side as a fuel ratio of the combustible gas to a total fuel increases, during fuel switching of the gasification combined cycle power plant between the combustible gas and another fuel having a higher calorific value than the combustible gas.
